(19) United States
(12) Patent Application Publication
(10) Pub. No.: US 2007/0299852 A1
(43) Pub. Date: Dec. 27, 2007

(54) Information sharing control system

(76) Inventor: Tatsuhiko Miyata, Kokubunji (JP)

Correspondence Address: REED SMITH LLP, Suite 1400, 3110 Fairview Park Drive, Falls Church, VA, 22042, US

(21) Appl. No.: 11/812,022

(22) Filed: Jun. 14, 2007

(30) Foreign Application Priority Data
Jun. 21, 2006 (JP) 2006-171838

(51) Int. Cl. G06F 17/30

(52) U.S. Cl. 707/10

(57) ABSTRACT

An information sharing control system including plural terminals for holding private relevant information containing identification information of other terminals or users, the private relevant information being created on the basis of transmitted/received e-mails or non-disclosed information or on the basis of a medium, and a first server for receiving a request for participation in an application or group from each of the terminals and storing attribute information for associating the identification information of the terminal with the identification information of the application or group, wherein respective terminals belonging to the same application or group temporarily share the private relevant information thereof on the basis of the attribute information.

### CLAIM OF PRIORITY

The present application claims priority from Japanese application JP 2006-171838 filed on Jun. 21, 2006, the content of which is hereby incorporated by reference into this application.

### BACKGROUND OF THE INVENTION

1. Field of the Invention

The present invention relates to an information sharing control system, and particularly to an information sharing control system for a setting manner for disclosure of information.

2. Description of the Related Art

There is known a mechanism called as Know-Who system for searching “a person” who knows information which a user wants to know. The operation of this system will be briefly described hereunder. In this system, the relationship among users is first achieved from the co-writing relationship of papers and transmission/reception information of e-mails, and grasped at the server side. Furthermore, the contents of papers and e-mails are likewise subjected to text mining, etc. so that knowledge information owned by respective users is grasped at the server side. With respect to information which a user wants to know, on the basis of the above two kinds of information, it is searched which persons are familiar with the information concerned among persons who have close ties to the user concerned. For example, if it is searched that a person B who is a friend of a user's friend A is familiar with the information concerned, it is possible that the information concerned is imparted from the person B to the user concerned through the friend A as an intermediary.

Furthermore, there exists a tool for visualize the organization structure of respective companies and the exchange state among staff members for consultant, etc. As in the case of the Know-Who system, this tool is actively used as a hint for grasping the transmission/reception state and contents of e-mails at the server side, grasp the relationship among staff members from the transmission/reception state and contents of the e-mails, and then advising the improvements of the present organization structure.

The present Know-Who system is based on the mechanism for achieving various information at the server side and grasp the connection among persons, and thus this system has a critical problem in privacy. It is preferable that the connection among persons are achieved from various public documents such as papers, reports, etc. However, for example, e-mails may contain information associated with privacy. For example, when information is achieved and analyzed at the server side, users may have a psychological resistance, and also there is a case where information or the like which is not wanted to be known by persons other than reliable friends may be known by persons other than desired persons.

### SUMMARY OF THE INVENTION

The present invention has been implemented in view of the foregoing point, and has an object to prevent the leaking of association information among users and personal information from intermediacy among persons in the Know-Who system. The present invention has another object to reduce the probability of disclosure of information (for example, the relationship among users) by jointly owning temporarily private connection information among persons (hereinafter referred to as inter-person connection information) among reliable users. Furthermore, the present invention has a further object to reduce the psychological resistance of users. Still furthermore, the present invention has a further object to establish a negotiation between a target person (information supplier) and an intermediary who has known ID or the address of the target person without disclosing information such as ID, an address or the like of the target person to a requester of intermediation (information demander) when the intermediation between persons (terminals) is carried out. Still furthermore, the present invention has a further object to prevent the information such as ID, the address, etc. of the target person to the requester even when the target person is not matched with the purpose of the requester or he/she does not agree with the negotiation after the negotiation.

Still furthermore, the present invention has a further object to construct a Know-Who system without for the server achieving the association information among users from an information source which may contain privacy such as e-mails or the like.

There is provided a mechanism for temporarily sharing (jointly owning) private connection information among persons (hereinafter referred to as “inter-person connection information”) possessed by respective members (users) when entrance/exit information into/from an electronic conference room, presence information, etc. of each user are checked and then these information pieces satisfies a condition for judging that the relationship of trust is established among the users. The private inter-person connection information contain connection information between a user and others which is achieved by analogizing the transmission/reception frequency and contents of e-mails of the user concerned at the terminal of the user concerned, and connection information with others which is achieved from information of the profile of the user concerned (company-entrance year, affiliated department, hobbies, etc.) which are not publicly opened.

Furthermore, there is provided a system in which when intermediation is carried out between users by using temporarily shared inter-person connection information, an intermediation wisher indicates public information of the name of a target person to request the intermediation to an intermediary, and the intermediary concerned indicates ID (identification information) of the target person to conduct negotiation for the intermediation purpose. Here, as ID may be used the IP address of a terminal used by the target object, an e-mail address used privately, ID of chat or the like.

FIGS. 1 and 2 are diagrams showing the operation. FIG. 1 is an image diagram when private relevant information is shared, and FIG. 2 is an image diagram showing an intermediation operation after an intermediation path is detected by using the private relevant information.

In FIG. 1, each of UserA represented by reference numeral 1, UserB represented by reference number 2 and UserC represented by reference numeral 3 owns relevant information representing how each of the Users A, B, C is connected to others as indicated by each of reference numerals 4, 5 and 6 (this relevant information will be also referred to as “others-relevant information”). At this time, when common conditions of the Users A, B and Care matched with one another as indicated by reference numeral 7, the relevant information 4, 5 and 6 among the Users 1, 2 and 3 is shared (jointly owned) as indicated by reference numeral 8. Thereafter, this shared relevant information 8 with others and public relevant information 9 owned by a relevant information sharable/non-sharable information managing server 16 are combined with each other, and an intermediation path to a target person is searched. After the intermediation path is searched, an intermediation request is made as indicated by step 12 of FIG. 2, and intermediation is carried out as indicated by steps 14 and 15. Finally, information is supplied as indicated by step 15. At this time, the intermediation is carried out so that the disclosure of privacy information such as IDs, addresses, etc. of the target person 11 and the intermediary 18 for the information supply is suppressed to the minimum level.

According to one feature of this system, values of various attribute information (object information) of respective users are compared with one another, and connection information which is owned by each user and indicates the relationship between the user concerned and others is shared when the comparison result is matched with a condition.

According to one feature of the server of this system, for example when information supply is carried out through an intermediation path to a target person, individual-specifying information owned by each of an intermediary and a target person is not supplied to an intermediation requester, a common symbol is distributed to the intermediation requester and the target person and the intermediary, only information which can be disclosed in each path from the common symbol is returned, whereby the information disclosure to each person is controlled. The information which can be disclosed is information such as names, etc. which each person makes publicly open.

In the above system, the various attribute information (object information) is entrance/exit information into/from an electronic conference room. Furthermore, the various attribute information (object information) is dynamically varying information such as position information of each user, the present state of each user or the like. Still furthermore, in the above system, the various attribute information (object information) is stationary information representing the feature of each individual such as an affiliated department, age, sexuality, etc. which is owned by each user.

At the information terminal of the above system, the connection information between the user concerned and others is held in each information terminal, and when the sharing condition is satisfied, communication is mutually carried out, whereby an intermediation path to a target person can be searched. Furthermore, the connection information between the users concerned and others may be temporarily registered in the server, and the server may control access according to the sharing condition.

In the above system, sharing or non-sharing of the connection information may be judged at the information terminal side. Furthermore, the attribute information of each user may be held in the server, and the condition matching of each user may be carried out in the server to thereby judge the coincident of the sharing condition.

In the above system, the sharing or non-sharing is stepwise defined, and the connection information between the user concerned and others to be disclosed is controlled in accordance with the level.

The search result of the intermediation path is temporarily returned to the information terminal of each user, and each user can select an intermediation path from the search result. Furthermore, the server may automatically select the intermediation path from the search result of the intermediate path, and carry out intermediation processing. Furthermore, as a result of the intermediation path search, the server can transmit the intermediation processing to a server for controlling a telephone, a character communication and an electronic conference, and control the communications between the target person and the intermediary or the intermediation request person.

According to the first solving means of this invention, there is provided an information sharing control system comprising:

plural terminals for holding private relevant information containing identification information of other terminals or users, the private relevant information being created on the basis of transmitted/received e-mails or non-disclosed information or non-disclosed medium; and

a first server for receiving a request for participation in an application or a group from each of the terminals and storing attribute information for associating the identification information of the terminal with the identification information of the application or the group,

wherein

respective terminals belonging to the same application or group temporarily share the private relevant information thereof on the basis of the attribute information.

According to the second solving means of this invention, there is provided an information sharing control system comprising:

plural terminals for holding private relevant information containing identification information of other terminals or users, the private relevant information being created on the basis of transmitted/received e-mails or non-disclosed information or non-disclosed medium;

a first server for receiving a request for participation in an application or a group from each of the terminals and storing attribute information for associating the identification information of the terminal with the identification information of the application or the group;

a second sever that has a database for storing identification information of users and information known by the users in association with each other, receives an information search request from a first terminal of the plural terminals, achieves the identification information of an information supply user knowing requested information by referring to the database, and transmits the identification information of the information supply user and the identification information of the first terminal; and

a third server for holding public relevant information in which identification information of mutually relevant terminals or users are associated with one another, the public relevant information being created on the basis of disclosed or disclosure-scheduled information or medium,

wherein the third server

receives the identification of the information supply user and the identification information of the first terminal from the second server,

determines identification information of each terminal belonging to the application or the group corresponding to the received identification information of the first terminal,

determines the identification information of the second intermediation terminal corresponding to the identification information of the first intermediation terminal corresponding to the received identification information of the information supply user or the identification information of the information supply user which is determined on the basis of the public relevant information, on the basis of the private relevant information of the terminal concerned, and

transmits an intermediation request to a second terminal according to the identification information of the determined second intermediation terminal;

the second intermediation terminal transmits an information supply request containing the identification information of the first terminal to the terminal of the information supply user directly or through the first intermediation terminal; and

the terminal of the information supply user displays the identification information of the first terminal on a display portion thereof and

according to the displayed identification information of the first terminal, the information supply user supplies the requested information to the user of the first terminal, whereby the requested information is supplied to the first terminal without disclosing the identification information of the intermediation terminal and the information supply user to the first terminal.

According to the third solving means of this invention, there is provided an information sharing control system comprising:

a fourth server for storing dynamically varying attribute information containing the position information and/or present state of each user for each identification information of the users;

a registering unit for registering the attribute information of each user into the fourth server; and

a terminal of each user or a third server for holding private relevant information containing identification information of other users, the private relevant information being created on the basis of transmitted/received e-mails or non-disclosed information or medium,

wherein

with respect to users having the same position information or predetermined presence information on the basis of the attribute information, the terminals of the users or the third server temporarily shares the private relevant information of the users respectively.

According to the present invention, it can prevent the leaking of association information among users and personal information from intermediacy among persons in the Know-Who system. According to the present invention, it can reduce the probability of disclosure of information (for example, the relationship among users) by jointly owning temporarily private connection information among persons (hereinafter referred to as inter-person connection information) among reliable users. Furthermore, according to the present invention, it can reduce the psychological resistance of users. Still furthermore, according to the present invention, it can establish a negotiation between a target person (information supplier) and an intermediary who has known ID or the address of the target person without disclosing information such as ID, an address or the like of the target person to a requester of intermediation (information demander) when the intermediation between persons (terminals) is carried out. Still furthermore, according to the present invention, it can prevent the information such as ID, the address, etc. of the target person to the requester even when the target person is not matched with the purpose of the requester or he/she does not agree with the negotiation after the negotiation.

Still furthermore, according to the present invention, it can construct a Know-Who system without for the server achieving the association information among users from an information source which may contain privacy such as e-mails or the like.

### BRIEF DESCRIPTION OF THE DRAWINGS

FIG. 1 is an image diagram when private relevant information is shared;

FIG. 2 is an image diagram showing an intermediation operation after an intermediation path is detected by using the private relevant information;

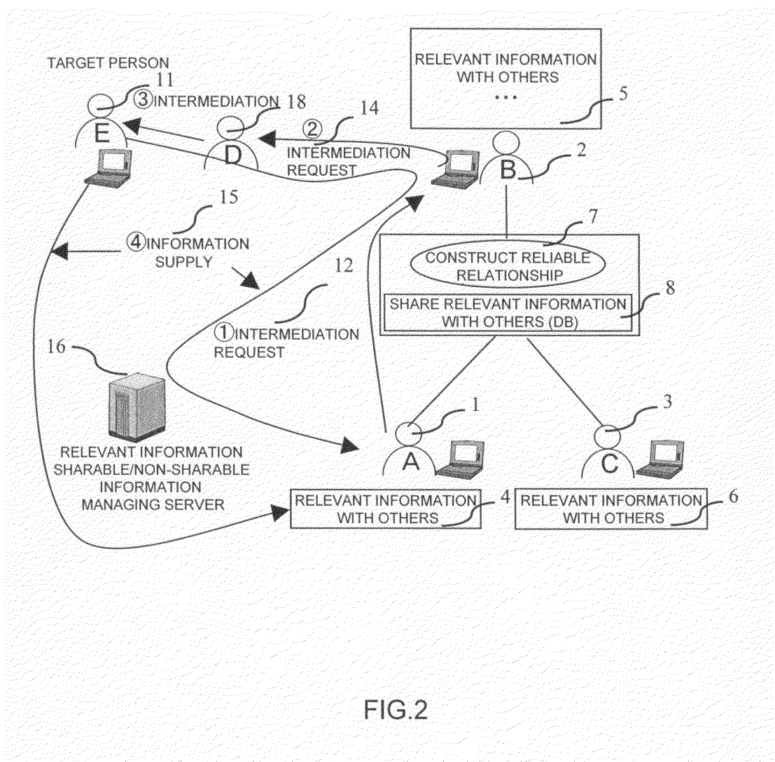

FIG. 3 is a conceptual diagram showing the operation of a first embodiment;

FIG. 4 is a diagram showing the physical construction and network of the first embodiment;

FIG. 5 is a functional block diagram showing an information terminal which is one construction of this system;

FIG. 6 is a functional block diagram showing a relevant information sharable/non-sharable information managing server which is one construction of this system;

FIG. 7 is a diagram showing the device construction of each server and an information terminal;

FIG. 8 is a sequence diagram (1) according to the first embodiment;

FIG. 9 is a diagram showing a data table of entrance/exit information of conference room;

FIG. 10 is a diagram showing a data table of private relevant information which is owned by each user;

FIG. 11 is a diagram showing a data table of public relevant information which is owned by each user;

FIG. 12 is a diagram showing a data table for judging the sharing level;

FIG. 13 is a sequence diagram (2) of another patter according to the first embodiment;

FIG. 14 is a sequence diagram (3) of another pattern according to the first embodiment;

FIG. 15 is a sequence diagram (4) of another pattern according to the first embodiment;

FIG. 16 is a sharing image diagram of the private relevant information according to the first embodiment;

FIG. 17 is an image diagram showing automatic intermediation according to the first embodiment;

FIG. 18 is a conceptual diagram showing the operation according to a second embodiment;

FIG. 19 is a diagram showing the physical construction and network of the second embodiment;

FIG. 20 is a sequence diagram according to the second embodiment;

FIG. 21 is a diagram showing a data table of presence information used in the second embodiment;

FIG. 22 is a diagram showing a data table of a matching condition and a sharing level used in the second embodiment;

FIG. 23 is a functional block diagram showing a multiperson conference control server which is one construction of this system;

FIG. 24 is a functional block diagram showing a Know-Who search server which is one construction of this system;

FIG. 25 is a diagram showing an intermediation format using intermediation ID of this system; and

FIG. 26 is a diagram showing a data table stored in the relevant information sharable/non-sharable information managing server used when intermediation ID is used in this system.

### PREFERRED EMBODIMENTS OF THE PRESENT INVENTION

### 1. First Embodiment

In this embodiment, a sharing sequence of private connection information with others which is owned by each user will be described by using a first example. In the following description, the logical structure, the physical structure of the server and the terminal of this embodiment and the network for connecting the server and the terminal will be briefly described. Furthermore, an example of a data table which is held and shared (jointly owned) by the terminal and the server of this embodiment will be described, and then plural operation sequence patterns in this embodiment will be described as a derivative from this example.

### (System Construction)

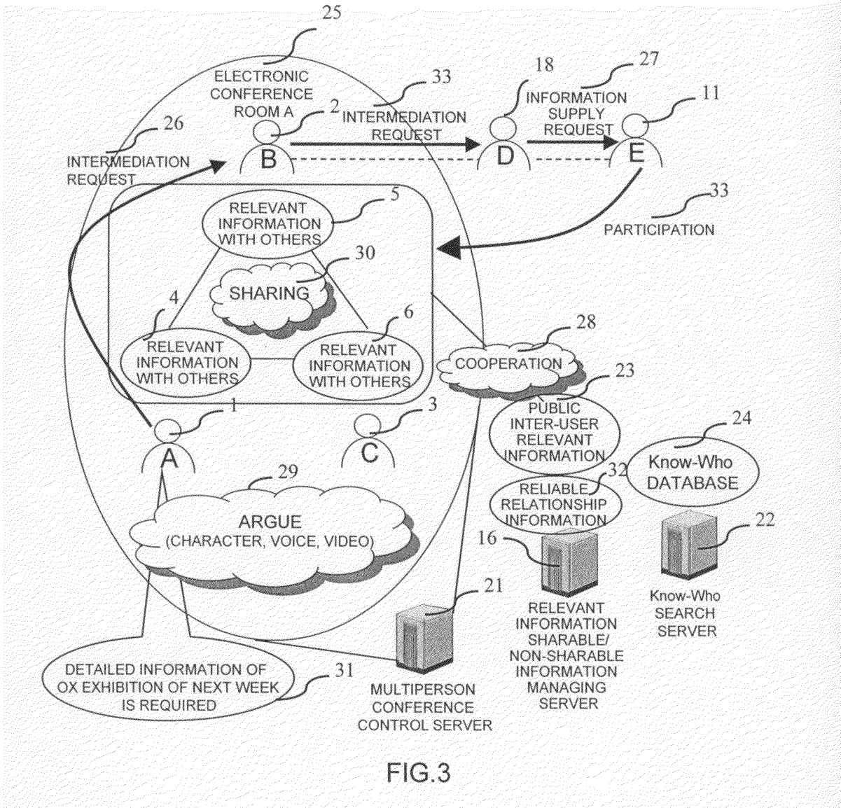

FIG. 3 is a conceptual diagram showing the operation of the first example of this embodiment.

This communication system comprises a relevant information sharable/non-sharable information managing server 16, a multiperson conference control server 21, a Know-Who search server 22, and plural terminals corresponding to plural users (for example, UserA, B, C, etc.). In the following description, User and person are merely described, however, they indicates terminals corresponding to these persons.

In FIG. 3, UserA represented by reference numeral 1, UserB represented by reference numeral 2 and UserC represented by reference numeral 3 enter an electronic conference room A25 managed by the multiperson conference control server 21, and have an argument by using any one of character, voice and video as indicated by reference numeral 29. However, in this example, the argument is made through chats based on characters, for example. For example, it is assumed that when an argument about a tomorrow's exhibition in the conference occurs, each user participating in the conference does not the detailed information about the exhibition. At this time, for example UserA requests a Know-Who search server 22 to search a user who knows the details about the tomorrow's exhibition. The Know-Who search server 22 searches a Know-Who database 24 owned by itself, and presents a target person who is expected to have the information. Thereafter, it cooperates the private relevant information 4, 5 and 6 owned by respective users and shared as indicated by reference numeral 30 on the basis of the contents of public inter-user relevant information 23 owned by the relevant information sharable/non-sharable information managing server 16 and the reliable relevant information 32, thereby presenting an intermediation path to the target person. Thereafter, UserA 1 outputs an intermediation request to UserB 2 as indicated by reference numeral 26, for example, and then UserB makes an intermediation request to UserD 18 as indicated by reference numeral 33. UserD 18 outputs an information supply request to UserE 11 as indicated by reference numeral 27, and UserE 11 participates in the electronic conference room A as indicated by reference numeral 33, for example. UserE 11 utters in the electronic conference room A, whereby information is supplied to UserE 11, UserA1 or the like.

Information terminals 41 to 43 holds (stores) private relevant information containing identification information of other terminals, which is created on the basis of e-mails or non-disclosed medium, for example.

The multiperson conference control server (first server) 21 receives a request for entrance to the electronic conference chamber A25 from the terminals 41 to 43, and stores attribute information in which the identification information of the terminals and the identification information of the conference room are associated with each other. In place of the conference room, a suitable application or group may be adopted. For example, the relevant information sharable/non-sharable information managing server 16 refers to the attribute information, and enables a terminal to temporarily share private relevant information when the terminal is matched with a condition that it belongs to the same application or group.

The Know-Who search server (second server) 22 has a database in which the identification information of users and the information which the users know are associated with each other. Furthermore, it receives an information search request from a first terminal out of plural terminals, and refers to the database to achieve and transmit the identification information of a user who knows the requested information.

The relevant information sharable/non-sharable information managing server (third server) 16 holds public relevant information which is created on the basis of a disclosed or disclosure-scheduled medium and associated with the identification information of relevant terminals. Furthermore, it receives the identification information of the target person from the Know-Who search server 22 and refers to the sharable private relevant information and/or the public relevant information to determine identification information of one or plural intermediation terminals for intermediation to the target person.

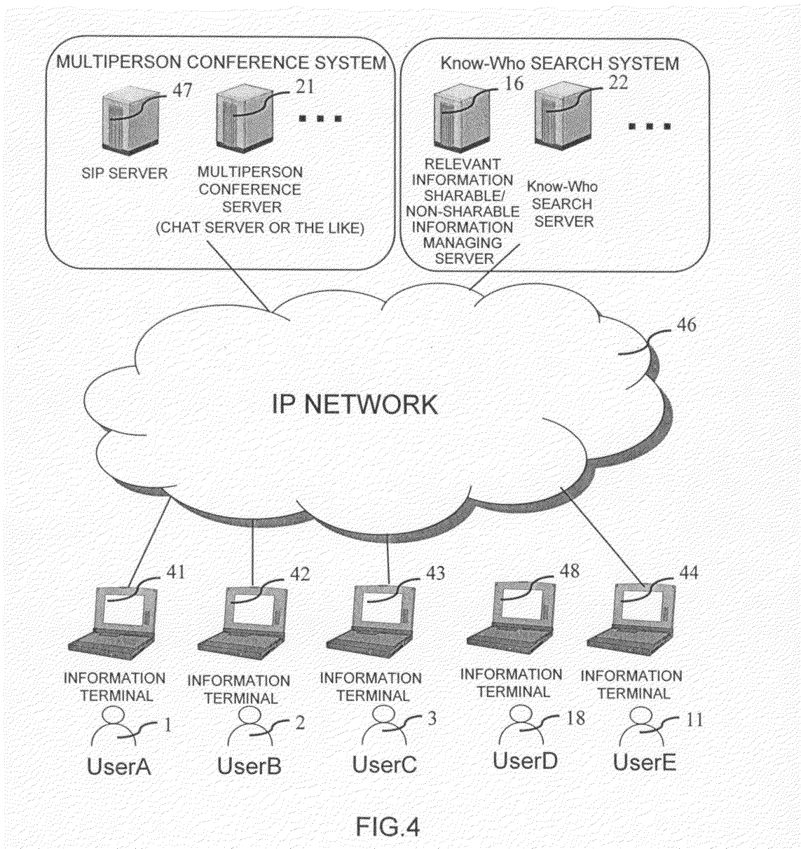

FIG. 4 is a diagram showing the physical connecting construction of the example of FIG. 3. UserA represented by reference numeral 1, UserB represented by reference numeral 2 and UserC represented by reference numeral 3 who participate in an electronic conference actually own and use information terminals 41, 42, 43 respectively, and connect to the multiperson conference control server 21 through an IP network 46. In this example, transmission/reception of character information, voice information, and picture information in the conference is controlled by SIP (Session Initiation Protocol) server 47. SIP is a protocol that controls the state from the calling of a partner user till the end of communication with the partner user about any communication between users such as character, voice and video and is standardized by IETF (Internet Engineering Task Force). In this example, SIP carries out the control operation, however, the control protocol is not limited to SIP. The relevant information sharable/non-sharable information managing server 16, the Know-Who search server 22, the information terminal 48 owned by User D 18 as the intermediary person and the information terminal 44 owned by UserE 11 as the target person are also connected to other servers and terminals through the IP network 46.

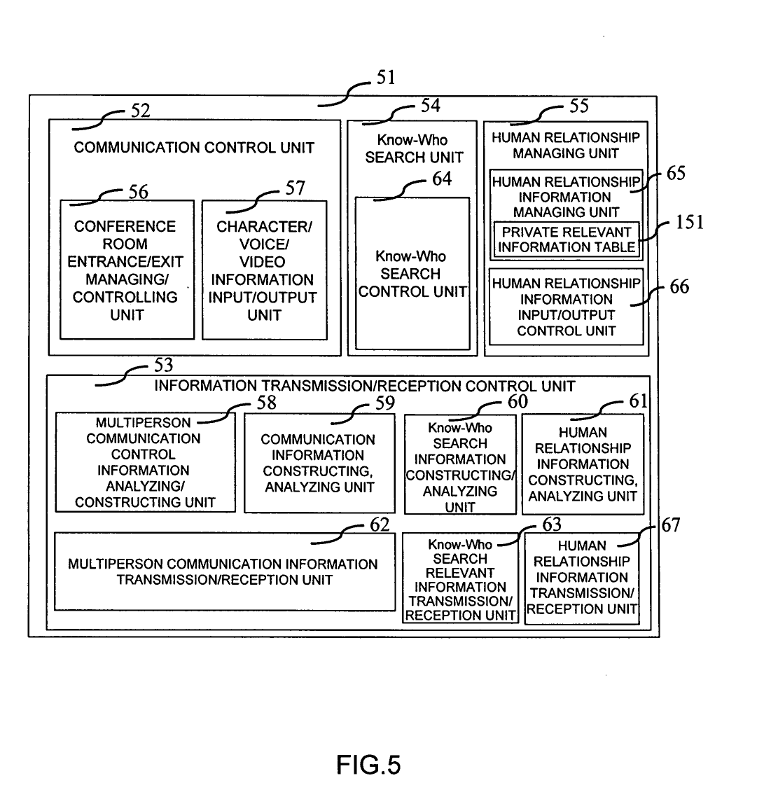

FIGS. 5, 6, 23 and 34 are functional block diagrams of the information terminals 41 to 43, the relevant information sharable/non-sharable information managing server 16, the multiperson meeting control server 21 and the Know-Who search server 22, respectively. The functional blocks shown in FIGS. 5, 6, 23 and 24 show the logical functional constructions implemented on software, however, these functional blocks may be constructed by hardware. The function of each block will be described hereunder.

FIG. 5 is a functional block diagram of the information terminal 51. The information terminal 51 corresponds to the terminals 41 to 43, etc. of FIG. 4. The terminals 44, 48 may have the same construction.

The information terminal 51 has a communication control unit 52, an information transmission/reception control unit 53, a Know-Who search unit 54 and a human relationship managing unit 55.

A conference room entrance/exit managing and controlling unit 56 of the communication control unit 52 in the block of FIG. 5 manages the entrance/exit state of the electronic conference room of the terminal thereof, and it accepts an entrance/exit request input from a user, carries out triggering of an external request, and receives conference room information from the external to grasp the state. A character/voice video information input/output unit 57 converts character/voice/video information used in the communication to a format for transmission to the external, or converts the information to a format for displaying received information to a terminal.

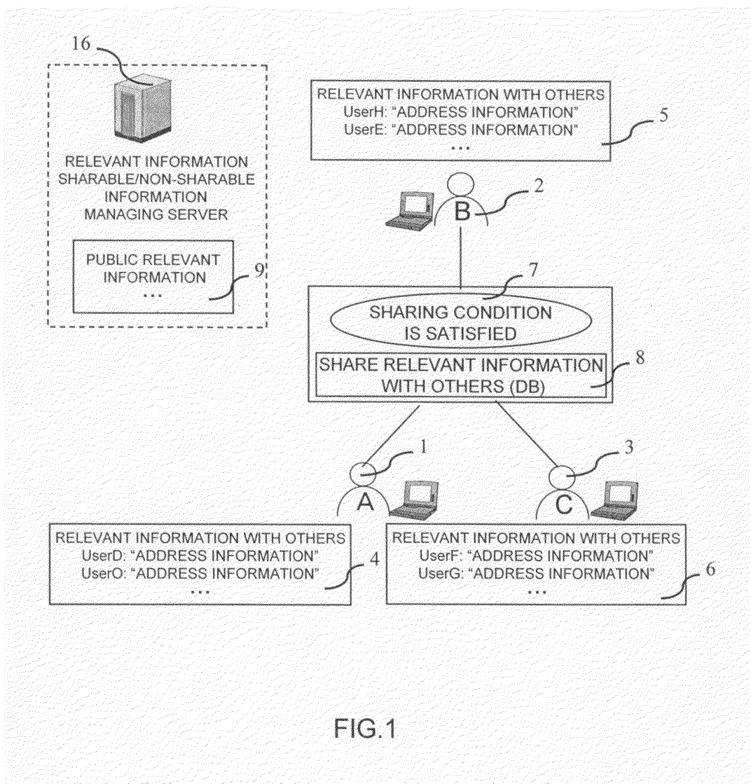

A Know-Who search control unit 64 of the Know-Who search unit 54 conducts triggering on the external request for Know-who search on the basis of a request from a user. Furthermore, it receives a search result message and notifies the result to the user. A human relationship information managing unit 65 of the human relationship managing unit 55 manages the relevant information (4, 5, 6 of FIG. 1) between the information terminal itself and others which is achieved from the information such as e-mails, etc. stored in a suitable storage portion of the terminal itself. A human relationship information input/output control unit 66 judges whether these information can be output or not, and accumulates the input information into the human relationship information managing unit 65.

The information transmission/reception control unit 53 is a block mainly serving as a protocol interface for carrying out communications with the external. A multiperson communication control information analyzing/constructing unit 58 carries out a message format conversion work matched with the communication protocol of the entrance/exit information for the conference room. A communication information constructing/analyzing unit 59 provides a message header matched with the communication protocol, converts to a suitable message length, etc. to transmit information of characters, voice, pictures/video, etc. used in the communication to the external. These messages are actually transmitted/received by a multiperson communication information transmission/reception unit 62. Furthermore, a Know-Who search information constructing/analyzing unit 60 carries out a message format conversion work matched with the communication protocol of the information on Know-Who search. This message is actually transmitted/received by a Know-Who search relevant information transmission/reception unit 63. A human relationship information constructing/analyzing unit 61 carries out a message format conversion work matched with the communication protocol of the human relationship information. This message is actually transmitted/received by a human relationship information transmission/reception unit 67.

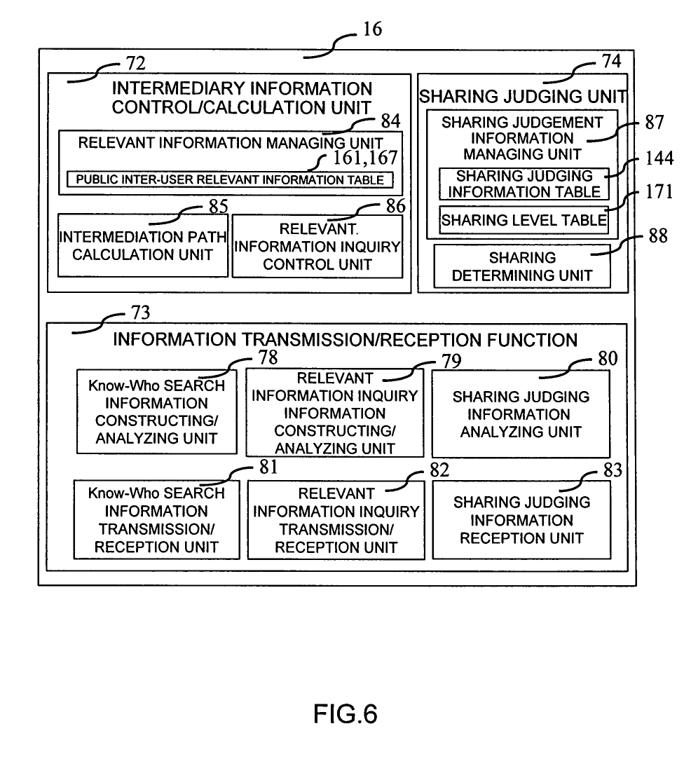

FIG. 6 is a functional block of the relevant information sharable/non-sharable information managing server 16.

The relevant information sharable/non-sharable information managing server 16 has an intermediary information control/calculation unit 72, an information transmission/reception function 73 and a sharing judging unit 74.

In this block diagram, a relevant information managing unit 84 of the intermediary information control/calculation unit 72 manages the publicly-managed inter-user relevant information and also manages private inter-use relevant information. For example, it has tables 161 and 167 for holding the public inter-use relevant information. An intermediation path calculation unit 85 calculates a third party user intermediating between users by using the information accumulated in the relevant information managing unit 84. A relevant information inquiry control unit 86 receives a calculation request of an intermediary or the like to conduct triggering of the operation of each block. Furthermore, it manages and controls reception of the request and return of the calculation result.

A sharing judgment information managing unit 87 of the sharing judging unit 74 manages information on the access control of the human relationship information which is held in the relevant information manger 84 by each user. The sharing determining unit 88 judges by using the access control information whether sharing is possible or not.

The information transmission/reception function 73 is a block mainly serving as a protocol interface for carrying out communications with the external. A Know-Who search information constructing/analyzing unit 78 carries out a message format conversion work matched with the communication protocol of the information on Know-Who search. This message is actually transmitted/received by a Know-Who search information transmission/reception unit 81. A relevant information inquiry information constructing/analyzing unit 79 carries out a message format conversion work matched with the communication protocol of information on the inquiry of relevant information based on the judgment of the sharing determining unit 88 to each terminal. This message is actually transmitted/received by the relevant information inquiry transmission/reception unit 82. A sharing judgment information analyzer 80 receives and analyzes a message in which information such as presence information managed by another server, entrance/exit information for the conference room, etc. is described. This message is actually received by a sharing judgment information receiver 83.

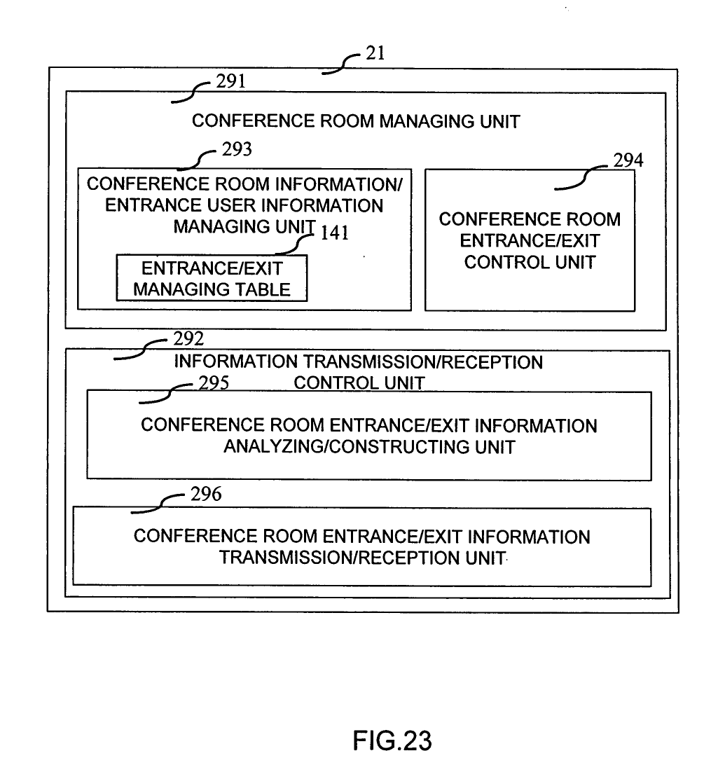

FIG. 23 is a functional block diagram showing the multiperson conference control server 21.

The multiperson conference control server 21 has a conference room managing unit 291 and an information transmission/reception control unit 292, for example.

In the block of FIG. 23, a conference room information/entrance user information managing unit 293 of the conference room managing unit 291 manages electronic conference rooms set up by this server 21 and manages the user entrance information to each conference room. A conference room entrance/exit control unit 294 accepts an entrance/exit request for an electronic conference room from each user, judges whether entrance/exit is possible or not, and conducts triggering on entrance/exit.

The information transmission/reception control unit 292 is a block mainly serving as a protocol interface for carrying out communications with the external. A conference room entrance/exit information analyzing/constructing unit 295 carries out a message format conversion work matched with the communication protocol of the information on the entrance/exit to and from the conference room. This message is actually transmitted/received by a conference room entrance/exit information transmission/reception unit 296.

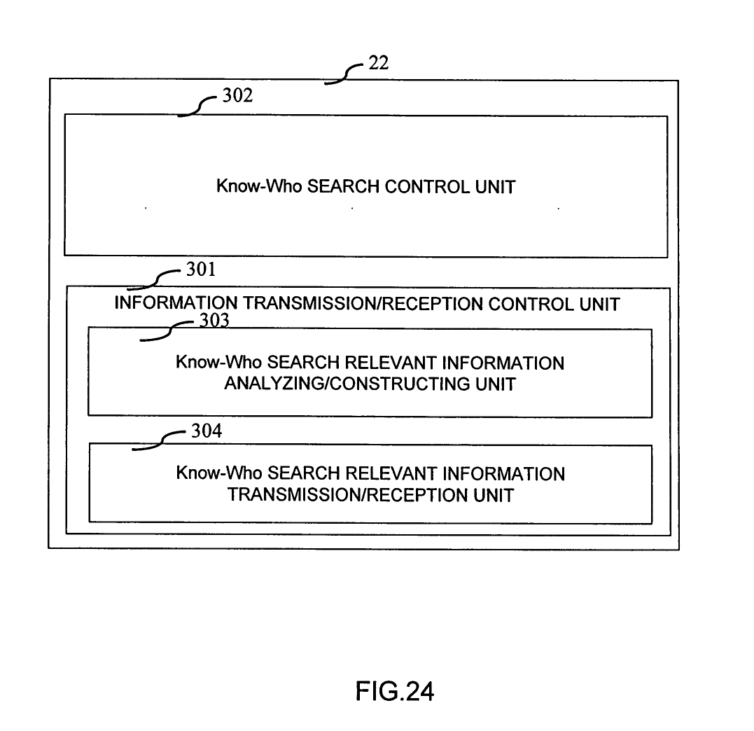

FIG. 24 is a functional block diagram of the Know-Who search server 22.

The Know-Who search server 22 has a Know-Who search control unit 302 and an information transmission/reception control unit 301, for example.

In this block, the Know-Who search control unit 302 carries out the actually relevant operation. For example, the Know-Who search control unit 302 refers to the know-Who database 24, and achieves identification information of a user who knows information relevant to input keywords. For example, in connection with keywords of information, the Know-Who database 24 achieves the identification information of a user who knows the information concerned. With respect to these information, information achieved from information disclosed in papers, etc. may be stored in the Know-Who database 24. Furthermore, the message conversion work matched with the communication protocol on the relevant information is carried out by a Know-Who search relevant information analyzing/constructing unit 303. The actual message transmission/reception is carried out by a Know-Who search relevant information transmission/reception unit 304.

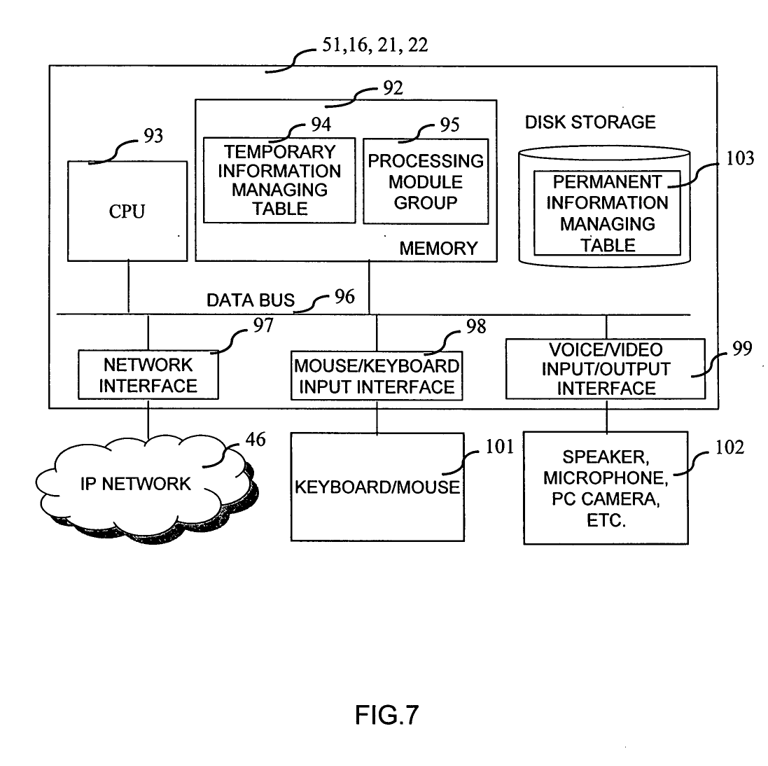

FIG. 7 shows how each function block of FIGS. 5, 6, 23 and 24 is implemented on hardware. Each device may have CPU (central processing unit) 93, a memory 92, a disk storage and respective interfaces 97, 98 and 99. Furthermore, each device may have an input unit, an output unit, a display unit, etc.

The operation procedures of the various functional blocks shown in FIGS. 5, 6, 23, 24 are accommodated in a processing module group 95 of a memory 92 shown in FIG. 7, and CPU 93 reads out and executes the operation procedures during operation. Information required when each processing module operates is stored in a permanent information management table 103 preserved on the disk storage such as a hard disk or the like and a temporary information management table 94 on the memory 92, and the information is read out or written as occasion demands. When the information terminals represented by reference numerals 41 to 44 carry out character communications, an input unit such as a keyboard, a mouse or the like as indicated by reference numeral 101 is connected to a mouse/keyboard input interface 98 for use. When voice, video communication is carried out, a device such as a speaker, a microphone, a PC camera or the like as indicated by reference numeral 102 is connected to a voice/video input/output interface 99 for use. Actual data is transmitted through a data bus 96 to CPU 93 to be processed. The terminals are connected to the IP network 46 through a network interface 97.

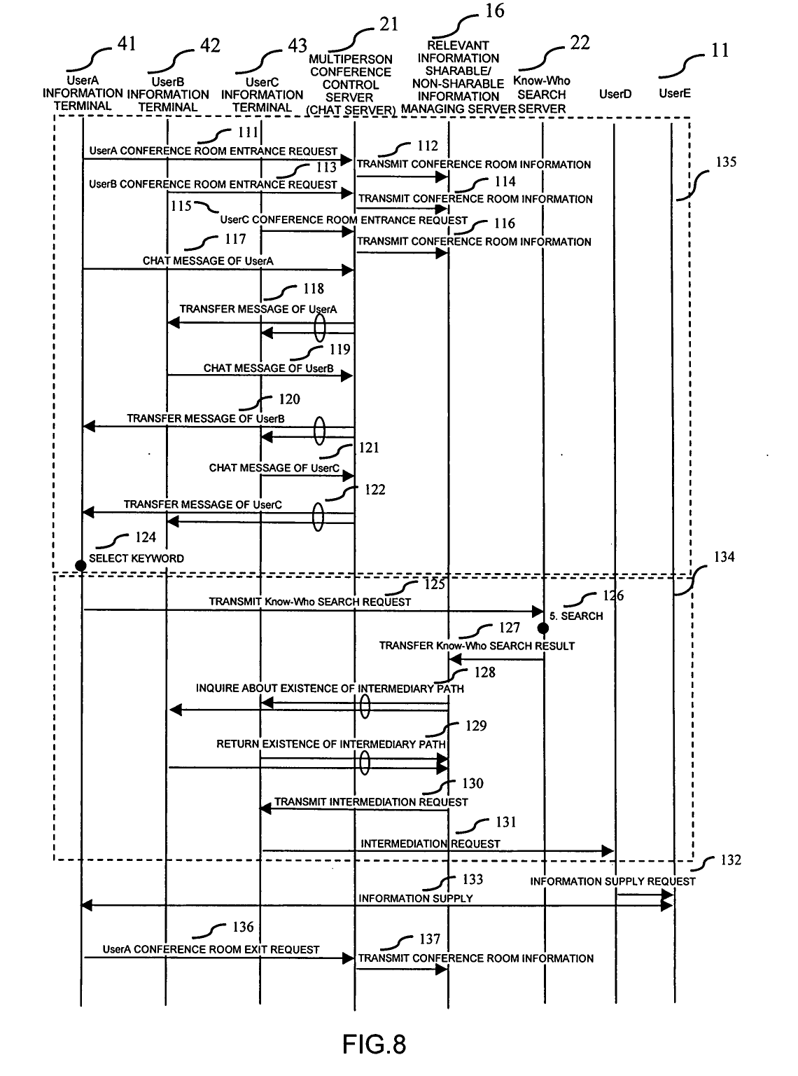

FIG. 8 is an operation sequence diagram of the embodiment shown in FIG. 3. The details of the operation content of FIG. 3 will be described on the basis of the sequence of FIG. 8.

First, the private relevant information owned in advance by each user before the operation of the sequence is started, and the public relevant information owned by the relevant information sharable/non-sharable information managing server will be described.

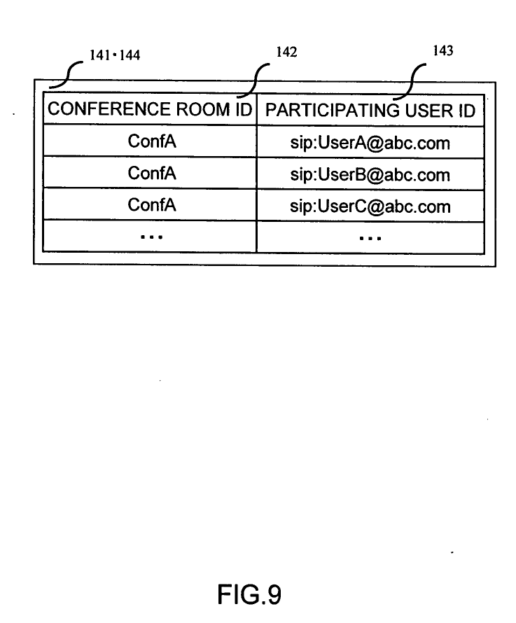

FIG. 9 is shows an example of a construction of the entrance/exit managing table 141. The entrance/exit managing table 141 stores the conference room ID of each electronic conference room and ID of User as a participating user in association with each other.

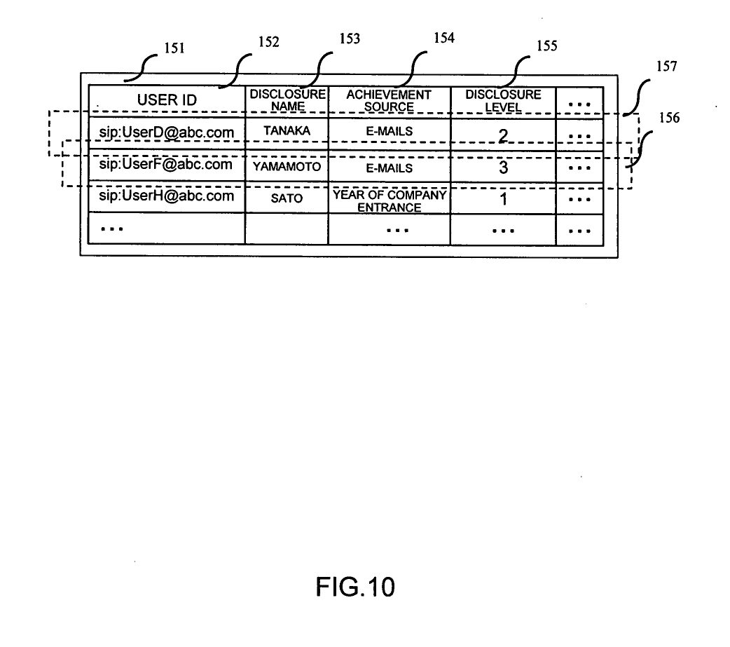

FIG. 10 is a diagram showing an example of the construction of a table 151 representing an example of the private relevant information owned by each user.

This table 151 describes the relationship between an owner of relevant information and a user having user ID represented in a field 152. A partner user ID is represented in the field 152. The appellation (for example, family name, name) of a target user ID which is open to the public is represented in a field 153, and this field will be described in detail later. A disclosure level of each relevant information is represented in a field 155. The disclosure level will be described in detail later as in the case of the field 153. In order to create the information to be described in the table 151, each user may analyze, on his/her own information terminal and by himself/herself, transmission/reception information of e-mails which are installed into the information terminal of each user and stored in an e-mail software. For example, an achieving source may be stored in a field 154. In this embodiment, the method of creating the information to be described in the table 151 is not limited to a specific one, and any method may be adopted. Furthermore, with respect to the construction of the table 151, since the intermediation path is carried out at higher speed in some systems, various information representing human relationship such as reliability degree or affinity degree may be added. However, any construction may be adopted for the table schemer insofar as it basically has a field as indicated by reference numeral 152 and a partner to be associated is known.

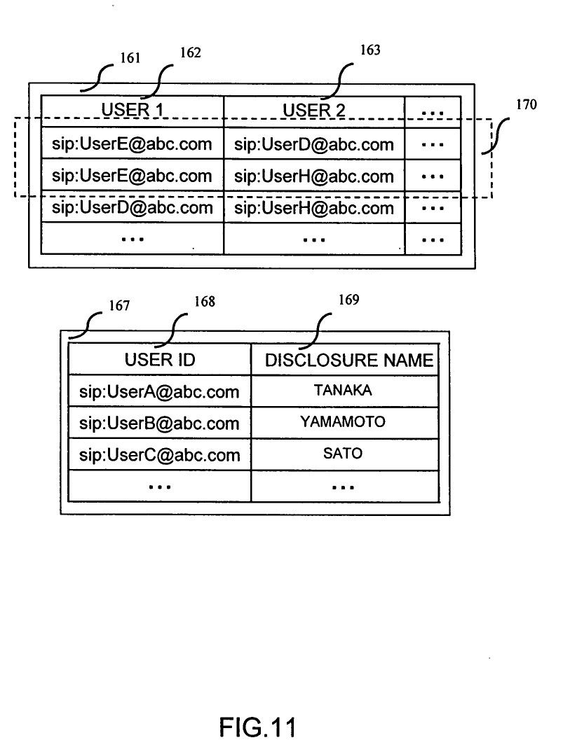

FIG. 11 is a diagram showing the construction of tables 161, 167 representing an example of the public relevant information owned by the relevant information sharable/non-sharable information managing server 21.

The table 161 shows that the user ID indicated by a field 162 and the user ID represented by a field 163 on the same record have relevancy to each other. In the table 167, it is indicated in a field 169 what appellation is disclosed for the user ID described in the field 168. This table will be described in detail later. With respect to the information to be described in the table 161, the co-writing relationship and reference relationship of disclosed information such as papers in academic societies, patent documents, etc. may be automatically analyzed to create relevant information, or relevant information may be manually input. For example, an author's name is extracted from papers, patent documents, research reports, etc., converted to user ID by referring to the table 167 and registered in the table 161. In this embodiment, the method of creating the information to be described in the table 161 is not limited to a specific one, and any method may be used to create the information. Information which is scheduled to be disclosed, information which is assumed to be disclosed, etc. may be further used in addition to the information which has been already disclosed. Furthermore, with respect to the construction of the table 161, various information representing human relationship may be added in some systems as in the case of the table 151. However, if information representing two users having a relation basically exist through the fields like the tables 162, 163, any construction may be adopted for the table schemer.

### 1-1. First Operation Pattern

Next, the specific operation content of each step of the sequence diagram will be described.

First, the information terminal 41 transmits a conference room entrance request to the multiperson conference control server 21 (step 111). The conference room entering request contains a conference room ID of conference room A to be entered (for example, confA) and user ID. More specifically, in order to enter the electronic conference room A indicated by reference numeral 25 of FIG. 3, the conference room entrance/exit control unit 56 of the communication control unit 52 shown in FIG. 5 in the information terminal 41 owned by UserA instructs the multiperson communication control information analyzing/constructing unit 58 of the information transmission/reception control unit 53 to create a conference room entrance request. The information terminal 41 transmits the entrance request to the multiperson conference control server 21 through the multiperson communication information transmission/reception unit 62 in step 111, and enters the electronic conference room A.

The multiperson conference control server 21 receives the conference room entering request and stores the conference room ID and the user ID in the received conference room entering request into the entrance/exit managing table 141. More specifically, when the multiperson conference control server 21 receives the request of the step 111 in the conference room entrance/exit information transmission/reception unit 296, it analyzes the content in the conference entrance/exit information analyzing/constructing unit 295, and notifies the analysis result to the conference room entrance/exit managing unit 294 of the conference room managing unit 291. When accepting this request, the conference room entrance/exit managing unit 294 stores the conference room ID of the electronic conference A indicated by reference numeral 25 of FIG. 3 and ID of UserA as a participant user as a pair in the fields 142, 143 respectively in the entrance/exit managing table 141 of the conference room as shown in FIG. 9 which is managed by a conference room information/entrance user information managing unit 293, and also records that UserA enters the conference room.

Furthermore, the conference entrance/exit managing unit 294 constructs the conference room information indicating the entrance of UserA to the electronic conference room A in the conference room entrance/exit information analyzing/constructing unit 295, and transmits the conference room information from the conference room entrance/exit information transmission/reception unit 296 to the relevant information sharable/non-sharable information managing server 16 (step 112). For example, the conference room information contains the conference room ID and the user ID. The relevant information sharable/non-sharable information managing server 16 receives the conference room information and registers it into the table 144. More specifically, the relevant information sharable/non-sharable information managing server 16 receives the information transmitted in step 112 by the sharing judgment information transmission/reception unit 83 in the information transmission/reception function 73 of FIG. 6, analyzes the information concerned in the sharing judgment information analyzing unit 80 and notifies the content thereof to the sharing judgment information managing unit 87 of the sharing judging unit 74. The sharing judgment information managing unit 87 holds the received information therein. As a result, the sharing judgment information managing unit 87 holds therein the same table 144 as the conference room entrance/exit managing table 141 shown in FIG. 9 which is owned by the multiperson conference control server 21. In this embodiment, the sharing judgment information transmission/reception unit 83, the sharing judgment information analyzing unit 80 and the sharing judgment information managing unit 87 which operate in this step respective receive, analyze and store the electronic conference room entrance/exit information held in the multiperson conference control server 21, however, the information to be treated is not limited to the information of this embodiment. In other systems, there is a case where the sharing judgment information is not the electronic conference room entrance/exit information, and in this case, the respective functional blocks receive, analyze and store the sharing judgment information in each system.

In the steps 113, 114 and 115, 116, the information terminal 42 of UserB and the information terminal 43 of UserC transmit the entrance request to the electronic conference room A indicated by the reference numeral 25 of FIG. 3 to the multiperson conference control server 21 as indicated by step 111, and transmits the information concerned to the relevant information sharable/non-sharable information managing server 16. The operations of the information terminal and each server in these steps are the same as the steps 111, 112.

As a result of the steps from step 111 to step 116, the information indicating that UserA, UserB and UserC enter the same conference room is held like the tables 141, 144 of FIG. 9 in the conference room information/entrance user information managing unit 293 of the multiperson conference control server 21 and the sharing judgment information managing unit 87 of the relevant information sharable/non-sharable information managing server 16. In this example, the conference room ID of the electronic conference room A indicated by the reference numeral 25 of FIG. 3 is represented by “ConfA”, and user IDs of UserA, UserB, UserC are represented by “sip:UserA@abc.com”, “sip:UserB@abc.com”, “sip:UserC@abc.com”, respectively. In this embodiment, by confirming that UserA, UserB, UserC enter the same conference room as in the case of the table 144, the relevant information sharable/non-sharable information managing server 16 can judge that the three users have reliable relationship at present and the private relevant information of each user can be shared by these users.

Thereafter, each user who entered the electronic conference room A carries out a character chat in the electronic conference room A (steps 117 to 122), for example. When UserA utters, characters input through the keyboard 101 of the information terminal 41 owned by UserA are transmitted to the character/voice/video information input/output unit 57 of the communication control unit 52 of FIG. 5. Furthermore, an information format which is matched with the protocol for the character chat is constructed in the communication information constructing/analyzing unit 59 of the information transmission/reception control unit 53, and transmitted from the multiperson communication information transmission/reception unit 62. The information thus transmitted is transmitted to the multiperson conference control server 21 as indicated in step 117 of FIG. 8. The multiperson conference control server 21 checks information registered in the table 141 of FIG. 9, and transmits the character information received in step 117 to UserB and UserC staying in the same conference room A as UserA in step 118. The same operation is carried out on the messages of the other users, and UserB's message and UserC's message are transmitted to the other users entering the same electronic conference room in steps 119, 120 and steps 121, 122, respectively.

In step 124, it is assumed that UserA interests the details of “OX exhibition” in the next week which is uttered by UserA in such a character chat and it is selected as a keyword. For example, a keyboard may be directly input, or characters or a word in the chat may be selected as a candidate, or one of them may be selected.

The information terminal 41 transmits a Know-Who search request containing the selected keyword and the user ID of itself (step 125). For example, the information terminal 41 owned by UserA constructs, in the Know-Who search information constructing/analyzing unit 60 of the information transmission/reception control unit 53, a Know-Who search request in which the interested “OX exhibition” is set as a keyword in the Know-Who search control unit 64 of the Know-Who search unit 54 of FIG. 5, and transmits the constructed Know-Who search request through the Know-Who search relevant information transmission/reception unit 63 to the Know-Who search server 22 in step 125.

Thereafter, the Know-Who search server 22 receives the information transmitted in step 125 by the Know-Who search relevant information transmission/reception unit 304 of the information transmission/reception control unit 301 of FIG. 24. Subsequently, the content of the request is analyzed by the Know-Who search relevant information analyzing/constructing unit 303, and notifies it to the Know-Who search control unit 302. When receiving the notification, the Know-Who search control unit 302 starts the Know-Who search in step 126. For example, the user (target person) corresponding to the keyword contained in the received Know-Who search request is achieved. The Know-Who search system is not limited in this embodiment, and any system may be adopted. In this example, it is assumed that a target person is UserE represented by reference numeral 3 as a result of the Know-Who search. In this example, UserE is only the target person. However, when plural persons are nominated as target person candidates, all the candidates may be notified.

Subsequently, the Know-Who search server 22 transmits the result of the Know-Who search to the relevant information sharable/non-sharable information managing server 16 (step 127). The user IDs of the target person (in this example, userE) and the person who wishes intermediation (in this example, UserA) are described in this information. Furthermore, the information may contain a keyword. The Know-Who search server 22 constructs transmission information in the Know-Who search relevant information analyzing/constructing unit 303 of the information transmission/reception control unit 301 shown in FIG. 24, and then transmits from the Know-Who search relevant information transmission/reception unit 304 to the relevant information sharable/non-sharable information managing server 16 in step 127.

The transmitted information is received by the Know-Who search transmission/reception unit 81 in the information transmission/reception function 73 of FIG. 6, then analyzed in the Know-Who search information constructing/analyzing unit 78 and then notified to the intermediation path calculation unit 85 of the intermediary information control/calculation unit 72.

The intermediation path calculation unit 85 first searches the public relevant information 161 preserved in the relevant information managing unit 84. The public relevant information is shown in the table 161 of FIG. 11. The intermediation path calculation unit 85 searches the intermediary candidate corresponding to UserE as the target person from this table. In this example, as a result of the check of the fields 162, 163 of the table 161, it is found that the UserD represented by sip:UserD@abc.com and UserH represented by sip:UserH@abc.com exist as persons relevant to UserE in the record 170. Accordingly, in this example, UserD and UserH are judged as intermediation candidates on the basis of the public relevant information.

Subsequently, in order to search a further detailed intermediary from the public relevant information, the intermediation path calculation unit 85 checks the intermediation request (desiring) person, and inquires to the sharing determining unit 88 of the sharing judging unit 74 shown in FIG. 6. In this embodiment, UserA represented by reference numeral 1 is the intermediation request (desiring) person. When accepting the inquiry, the sharing determining unit 88 checks the sharing judgment information 144 accumulated in the sharing judgment information managing unit 87, checks users with which UserA can share the relevant information, and notifies the sharable user ID to the intermediation path calculation unit 85. In the foregoing description, according to this embodiment, the sharing judgment information 144 has the same information as the table 141 of FIG. 9, and users staying in the same electronic conference room can share the relevant information with one another. Accordingly, in this embodiment, it is judged that UserA can share the relevant information with UserB (sip: UserB@abc.com), UserC (sip:UserC@abc.com) who stay in the same electronic conference room as described in the table 144. The relevant information sharable/non-sharable information accumulating server 16 does not have the table 144, and may inquire to the multiperson conference control server 21. When one of users known from the public relevant information is identical to a user staying in the electronic conference room A, the processing may be shifted to step 130 with omitting the following steps 128, 129.

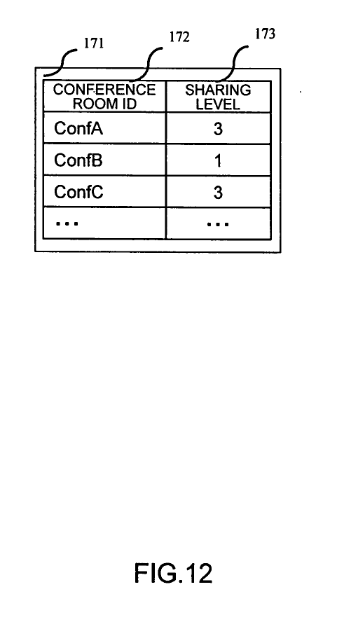

According to this embodiment, with respect to the sharing of the relevant information, not only a simple “sharable” or “non-sharable” judgment is made, but also the sharing level may be set so that the sharing range is stepwise changed. When the sharing level is set, the sharing judgment information managing unit 87 holds a template table for judging the sharing level like a table 171 shown in FIG. 12 in addition to the table 141 of FIG. 9. The conference room ID and the sharing level are described in the fields 171 and 172 respectively in association with each other. By using the table 171, the sharing level when respective users stay in the same conference room is judged in each electronic conference room. In this embodiment, with respect to the electronic conference room A of FIG. 3, the conference ID is set to “ConfA” as described above, and thus it can be judged from the table 171 that the sharing level is equal to 3.

Furthermore, the disclosure-allowance level of each relevant information between the user concerned and others is described in the disclosure level field 155 of the others-relevant information which is owned by each user and indicated in the table 151 of FIG. 10. For example, with respect to the relevant information indicated in the record 156, the value of the disclosure level field 155 is equal to 3, and thus the relevant information concerned is allowed to be disclosed to only other users who share the relevant information at the sharing level of 3 or more. In this example, the value of the sharing level is represented by a numerical value, however, the expression method is not limited to this style. However, even when any expression method is adopted, with respect to the relevant information of other users, each user can refer to only relevant information whose disclosure level is equal to or lower than the set sharing level. By setting the sharing level as described above, each user can allocate the level of importance to the others-relevant information, and thus the disclosure level can be minutely set on the basis of the relationship. For example, this disclosure level may be set on the basis of the following policy. That is, the contents of the e-mails are subject to text analysis, and the formality degree of the content of transmitted e-mail information is checked. The disclosure range is varied in conformity with the formality degree. That is, in the case of formal relationship, the disclosure range is expanded (the disclosure level is set to a lower value). Conversely, in the case of informal relationship, the disclosure range is narrowed (the disclosure level is set to a large value). However, the allocation method of the disclosure level of this embodiment is not limited to a specific one, and any method may be adopted.

The relevant information sharable/non-sharable information managing server 16 inquires about the existence of an intermediation path to UserB, UserC who are judged as being sharable (step 128). It is described in the message for the inquiry concerned that the target person is UserE and the intermediary candidates are UserD, UserH.

The intermediation path calculation unit 85 of the relevant information sharable/non-sharable information managing server 16 outputs an inquiry instruction to the relevant information inquiry control unit 86. In step 128, the relevant information inquiry control unit 86 transmits a check message inquiring about whether UserB, UserC to which the sharing relationship is confirmed have relationship with the target person, from the relevant information inquiry transmission/reception unit 82 through the relevant information inquiry information constructing/analyzing unit 79 to UserB, User C so as to inquiry about whether UserB, UserC can execute intermediation with the target object. It is described in this message that the target person is UserE and the intermediary candidates are UserD, UserH. Furthermore, in addition to the target person and the intermediaries, the user ID of the intermediation wisher (requester) and the presently sharing condition are also described in this message. This is to confirm whether the user terminal of the transmission destination is truly under sharing state. In this example, the procedure will be described on the basis of the case where the sharing level is set in the form of the table 171 of FIG. 12. When the sharing level is set, the sharing level is notified in step 128 at the same time to notify how degree the inquiring user considers the sharing level.

The message transmitted in step 128 is received by the Know-Who search relevant information transmission/reception unit 63 of the information terminal 42, 43 (the internal construction thereof is represented by reference numeral 51 of FIG. 5) owned by each of UserB, UserC, and notified to the human relationship information input/output control unit 66 of the human relationship managing unit 55 via the human relationship information constructing/analyzing unit 61. The human relationship information input/output control unit 66 first checks the intermediation wisher and the relation sharing condition. The check of the sharing may be automatically carried out by the terminal, or the user may be requested to manually check the sharing. If the sharing is confirmed, then the relevant information 151 between the user concerned and others which is preserved in the human relationship information managing unit 65 is searched, and it is judged to the target person or the intermediary candidates achieved from the public relevant information whether intermediation is possible or not. The human relationship information managing unit 65 holds the private relevant information of each user as shown in the table 151. The table 151 shown in FIG. 10 is an example of the table held by UserC, and in this example, an operation example is shown by using this table. It can be confirmed in the table 151 that UserD as the intermediary candidate in this example exists in the record 157. Furthermore, the value of the disclosure level field 155 of the record 157 is equal to 2, and thus it is lower than the sharing level 3 of this example. Accordingly, it can be confirmed that disclosure is possible in response to the inquiry. As a result of the check of the table 151, the human relationship information input/output control unit 66 of the information terminal 43 owned by UserC judges that the intermediary candidate UserD achieved from the public information can execute the intermediation. Likewise, it judges that the intermediary candidate UserH can execute the intermediation.

The information terminal 43 notifies the result from the Know-Who search relevant information transmission/reception unit 63 through the human relationship information constructing/analyzing unit 61 to the relevant information sharable/non-sharable information managing server 16 in step 129. The information terminal 42 owned by UserB executes the same processing, and likewise notifies the result to the relevant information sharable/non-sharable information accumulating server 16 in step 129. For example, the information terminal 42 may notify to the relevant information sharable/non-sharable information accumulating server 16 that the intermediation is impossible.

The relevant information sharable/non-sharable information managing server 16 receives the result to the inquiry from the terminals 42, 43 of the respective users, determines an intermediation request destination, an intermediary, and transmits an intermediation request (step 130). UserC is determined as the intermediation request destination and UserD (or UserH) is determined as the intermediary. The intermediation request contains ID of the target person and ID of the intermediary, for example. The intermediation request may further contain a keyword and ID of a requester (in this example, UserA). In this example, both the public relevant information and the private relevant information are referred to, however, only one of them may be referred to if the intermediation path is settled.

More specifically, the relevant information sharable/non-sharable information accumulating server 16 receives the message of the step 129 by the relevant information inquiry transmission/reception unit 82, and notifies it through the relevant information inquiry information constructing/analyzing unit 79 to the relevant information inquiry control unit 86, and further the relevant information inquiry control unit 86 notifies the content thereof to the intermediation path calculation unit 85. The intermediation path calculation unit 85 selects the intermediation request destination on the basis of the result concerned, and transmits the intermediation request from the relevant information inquiry transmission/reception unit 82 through the relevant information inquiry information constructing/analyzing unit 79. In this example, the intermediation request is transmitted to UserC in step 130. Furthermore, if a notification indicating that the intermediation is possible is received from plural users through the above processing, the server selects a user to which the intermediation request is actually transmitted. However, in this embodiment, the selecting method of the user concerned is not limited, and any method may be used. As described above, the relevant information sharable/non-sharable information managing server 16 combines the public relevant information as shown in the table 161 and the private relevant information as shown in the table 151 owned by the user who satisfies the sharing condition with the intermediation wisher, thereby selecting the final intermediary, and transmits the intermediation request.

The information terminal 43 of UserC receives the intermediation request, requests the intermediation to the intermediary UserD in response to the received intermediation request (step 131), and UserD requests the target person UserE to supply information (step 132).

For example, the information terminal 43 transmits ID of the target person UserE, ID of the requester UserA and the intermediation request containing the keyword, etc. to the information terminal 48 of UserD according to the received intermediation request, for example. The information terminal 48 transmits ID of the requester UserA and the information supply request containing the keywords, etc. to the information terminal 44 of UserE according to the intermediation request from the information terminal 43, for example. When receiving the information supply request, the information terminal 44 displays the keyword, the requester, etc. on the display portion. UserE knows from the displayed information that there is a request, and supplies information to UserA.

In steps 131, 132, in place of the operation that the terminal automatically transmits the request as described above, for example, the information terminal 43 may display the received intermediation request on the display portion and then UserC watching the display may request UserD.

More specifically, the information terminal 43 owned by UserC receives the message of the step 130 by the human relationship information transmission/reception unit 67, and notifies it through the human relationship information constructing/analyzing unit 61 to the human relationship information input/output control unit 66. The human relationship information input/output control unit 66 displays the information concerned on the screen of the terminal, and notifies to UserC that the intermediation request is received. UserC makes the intermediation request to UserD indicated by reference numeral 18 on the basis of the information concerned in step 131. Furthermore, UserD makes the information supply request to UserE indicated by reference numeral 11. As the request method in steps 131, 132 may be adopted various methods for making a request by chat, by telephone, by directly meeting, etc. However, in this method, any method may be adopted.

Furthermore, UserE represented by reference numeral 11 finally supplies information to UserA represented by reference numeral in some style as indicated by step 133. Specifically, UserE may adopt various methods of supplying information to UserA, for example, he/she participates in the electronic conference A, and directly supplies information to the information terminal 41 of UserA, or telephones UserA to supply information, or makes an appointment to directly meet UserA and supply information to UserA or the like. However, any method may be adopted to supply information to UserA.

Furthermore, for example when the information terminal 41 of UserA transmits an exit request message from the electronic conference room A to the multiperson conference control server 21 as indicated in step 136 and thus UserA represented by reference numeral 1 exits from the electronic conference room A, the information concerned is transmitted from the multiperson conference control server 21 to the relevant information sharable/non-sharable information managing server 16 as indicated by step 137. As a result, the record that UserA stays in the electronic conference room A is deleted from the table 144 of FIG. 9 which is managed by the relevant information sharable/non-sharable information managing server 16, and the sharing of the relevant information is released. The same operation is also carried out when the terminals 42, 43 transmit the exit request.

In this example, UserA does not receive messages from the server and the other users until all the sequences are finished after transmitting the Know-Who search request in step 125. Accordingly, the information on the target person and the intermediary is never notified to UserA. As described above, the target person and the intermediary are not notified to the requester UserA, and thus even when the intermediation is not established, the information on the intermediary and the target person can be prevented from being leaked to UserA.

### (Modification of First Operation Pattern)

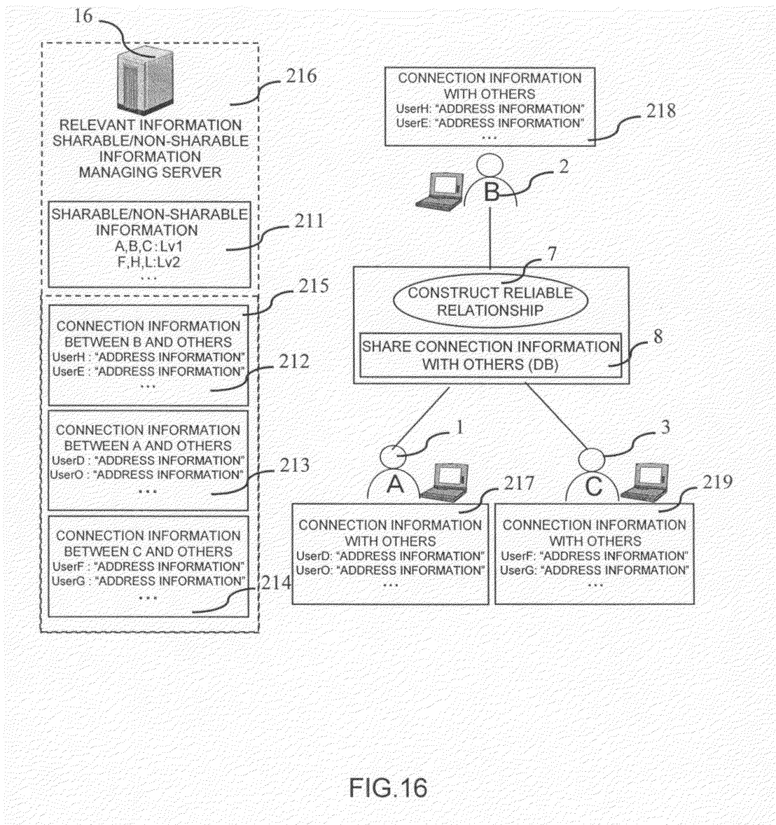

FIG. 16 is a sharing image diagram of private relevant information according to a first embodiment.

In the above example, each user holds private relevant information as indicated by reference numerals 217, 218, 219 of FIG. 16. The relevant information sharable/non-sharable information managing server 16 identifies sharable other users from the information of the tables 144, 141 preserved as indicated by reference numeral 211, and transmits an inquiry message to UserB, UserC to search an intermediary from private information in step 128 of FIG. 8. As another method may be considered such a method that UserA, UserB, UserC notifies the private relevant information of the respective users into the relevant information sharable/non-sharable information managing sever 16 in advance as indicated by reference numerals 212, 213, 214, and the relevant information sharable/non-sharable information managing server 16 searches information stored therein.

When each user holds the private relevant information by itself as indicated by reference numerals 217, 218, 219, the private relevant information is managed in the information terminal owned by each user, and thus physical security can be secured. On the other hand, when the private relevant information is preserved in the server 16 as indicated by reference numerals 212, 213, 214, physical security cannot be secured, however, logical security can be secured by carrying out access control on the basis of the sharable/non-sharable information 211 (sharing judgment information table 144). When the private relevant information is preserved at the server 16 side, the sequences shown in steps 128, 129 of FIG. 8 may be omitted, and the communication cost can be reduced. When the private relevant information is held in the server 16, each of the terminals 41 to 43 is required to register the relevant information owned by itself into the server 16. In this embodiment, the registration timing is not particularly limited, however, a newly calculated content may be registered in the server every time each of the terminals 41 to 43 calculates the relevant information.

### 1-2. Second Operation Pattern

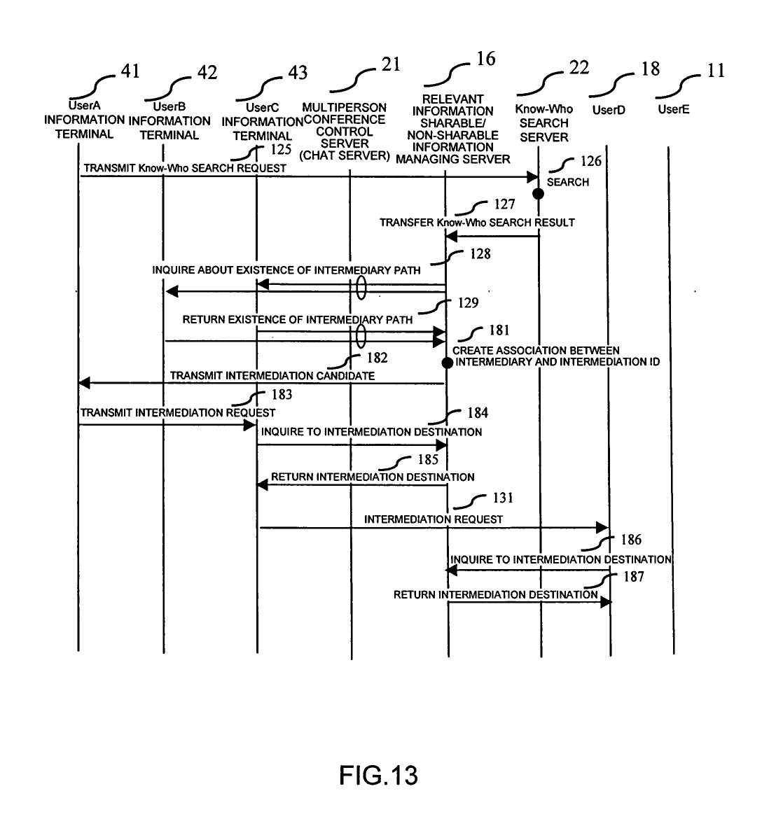

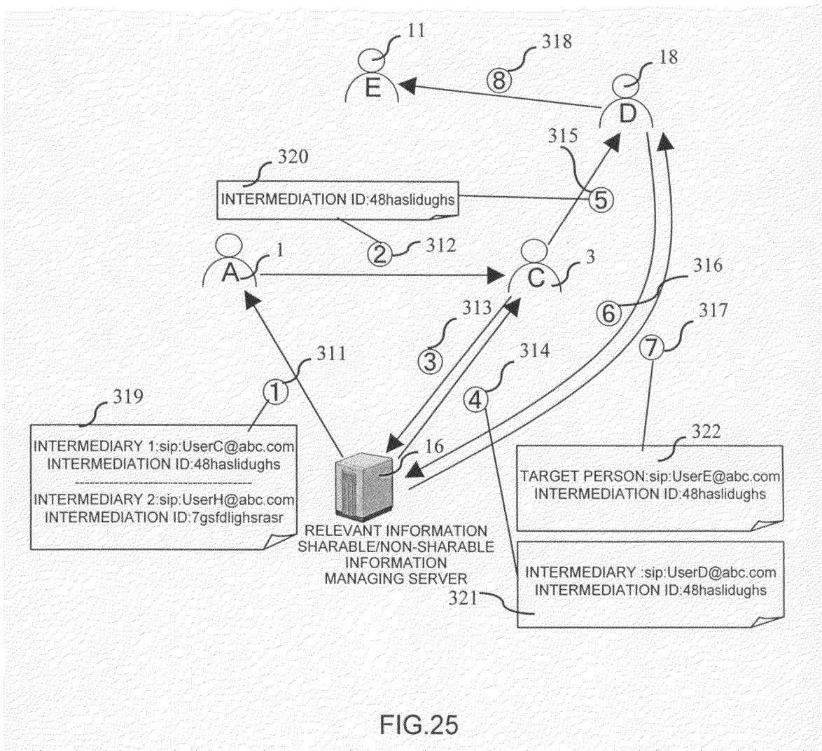

FIG. 13 is a sequence diagram showing the second operation patter for the portion surrounded by reference numeral 134 of the sequence diagram of FIG. 8. In this sequence, the operation of the steps 125 to 129 are the same as the example of FIG. 8. In the above example, in step 130 of FIG. 8, the relevant information sharable/non-sharable information managing server 16 transmits the intermediation request message to UserC. However, in this example, the relevant information sharable/non-sharable information managing sever 16 temporarily notifies the intermediary achieved as a search result to UserA in step 182. Thereafter, UserA directly transmits an intermediation request to UserC in step 183. In the pattern of FIG. 8, it is unnecessary that the Ids of UserC, UserD as intermediaries and UserE as the target person are transmitted to UserA when the intermediation request is made, and thus the sequence can be executed with hiding the IDs. However, in this sequence pattern, User directly requests intermediation to UserC in step 182, and thus it is necessary that UserA knows at least Id of UserC as the first intermediary. The relevant information sharable/non-sharable information managing server 16 may notify ID of UserC to UserA in step 182. On the other hand, with respect to IDs of UserD as the second intermediary and UserE as the target person, the sequence can be executed without notifying the IDs concerned by using the method shown in FIG. 25. The operation of FIG. 25 will be described in order.

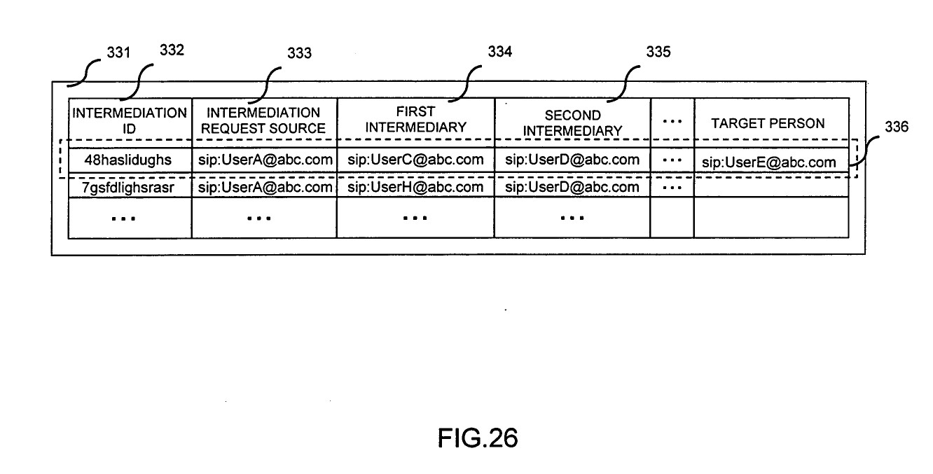

FIG. 25 is a diagram showing the intermediation style of the operation pattern, and FIG. 26 shows an example of the construction of the intermediation ID table.

In FIG. 25, when the relevant information sharable/non-sharable information managing server 16 calculates candidates of the intermediary, unique IDs are allocated to these intermediation paths in step 181 of FIG. 13 in the server, and the information thereof is held in such a format as a record 336 in the table indicated by reference numeral 331 of FIG. 26. Reference numeral 332 of FIG. 26 represents a unique intermediation ID, and reference numerals 333, 334, 335 represent intermediation paths. With respect to the intermediation paths 333 to 335, the number of fields is varied in accordance with the number of persons on the intermediation paths. When there are three intermediaries, a field for describing “third intermediary” is prepared at the right side of the reference numeral 335 although it is omitted in this example, and ID of the third intermediary is filled in the field concerned. In the example of the field 336, ID of UserA as an intermediation source is stored, IDs of UserC, UserD are stored as intermediaries, and ID of UserE as the target person are stored. As these information may be used the information received in step 127, the public relevant information and the return information to the inquiry from UserB, C.

Subsequently, the relevant information sharable/non-sharable information managing server 16 notifies the candidate of the intermediary (in this case, UserC, for example) and the target person to UserA represented by reference numeral 11 in step 311. This operation corresponds to the step 182 of the sequence diagram of FIG. 13. Reference numeral 319 of FIG. 25 represents information to be transmitted in this step. In this information are described IDs of UserC, UserH as the candidates of the intermediary and the intermediation ID in the case of the intermediation of each intermediary. UserA selects one of these candidates to which the request is output, and transmits the intermediation request to the selected candidate. As described above, the sequence pattern of FIG. 13 has a merit that when plural intermediary candidates are found, UserA himself/herself can actually select a person to which the intermediation is requested. In this example, UserA selects UserC.

Therefore, UserA transmits the intermediation request to UserC in step 312. This step corresponds to the step 182 of the sequence diagram of FIG. 13. Reference numeral 320 of FIG. 25 represents information transmitted in this step. The information is provided with the intermediation ID information in the information indicated by reference numeral 319. User B (represented by reference numeral 3) receiving the intermediation request in step 312 transmits the intermediation ID to the relevant information sharable/non-sharable information managing server 16 to specify the intermediation path from the intermediation ID information received in step 313. This step corresponds to the operation of the step 184 of FIG. 13.

The relevant information sharable/non-sharable managing server 16 searches the table indicated by reference numeral 331 of FIG. 26, and checks the intermediation path from the received intermediation ID. In this example, it can be confirmed that the value of the intermediation ID field 332 of the record 336 is coincident with the receive intermediation ID. The relevant information sharable/non-sharable information managing server 16 confirms that the transmission source of the intermediation request is UserA and the user requesting the intermediation path is UserC, and returns to UserC the user name and ID which are next relayed from the record 336 by UserC. This operation corresponds to the step 185 of FIG. 13. In this example, the intermediary to which UserC relays is UserD having ID of sip:UserD@abc.com described in the field 335, and thus this fact is returned to UserC while it is described as indicated by reference numeral 321.

Thereafter, UserC transmits the intermediation request to the next intermediary UserD as indicated by step 315 (step 131 of FIG. 13). As in the case of UserC described above, UserD inquiries the intermediation path to the relevant information sharable/non-sharable information managing server 16 in step 316 (step 186 of FIG. 13) and receives information as indicated by reference numeral 322 in step 317 (step 187 of FIG. 13). UserD finally requests information supply to UserE in step 318 (step 132 of FIG. 8). The steps 315 to 317 are the same as the steps 312, 313 and 314. However, the user to be next relayed by UserD is not an intermediary, but the target person, and thus this fact is described in reference numeral 322. UserD checks this fact, and makes, not intermediation request, but the information supply request to the destination to be next relayed.

In the above example, the intermediation work is implemented by using the intermediation ID. However, when the intermediation ID is not used, the sequence of steps 181, 184, 185, 187 of FIG. 13 and the steps of 313, 314, 316 and 317 of FIG. 25 does not occur.

In addition to the merit that the intermediary can be selected, the sequence pattern in which the intermediation wisher directly outputs an intermediation request as described above has a merit that the details of the purpose can be directly notified to the intermediary at the intermediation request time.

Furthermore, in this example, there is described the method in which the IDs of the intermediary D and the target person E other than the directly requested person C are not notified to the intermediation wisher A. However, when there would be induced no problem in view of the security level even if disclosure is made, for example, the ID of the intermediary and the ID of the target person are transmitted to the reference numeral 319 or 329 of FIG. 25, for example. When ID is supplied, it is unnecessary that the intermediation path is inquired to the relevant information sharable/non-sharable information managing server 16 as indicated by the steps 313, 314, 316 and 317 of FIG. 25.

Furthermore, there exists a case where ID of the target person E is not disclosed to the intermediation wisher A. For example, in a case where the intermediary C, D executes intermediation to the target person, when he/she call to a cellular phone which is privately owned by the target person, the telephone number of the cellular phone as the ID of the target person should not be disclosed to the intermediation wisher. In such a case, the ID of the target person is not disclosed to the intermediation wisher, but only information having low secrecy such as the name of the target person or the like may be disclosed. In addition to the public relevant information, the relevant information sharable/non-sharable information managing server 16 holds the combination of a user ID field 168 and a field 169 in which a disclosure name such as the name of the user is described as in the case of the table 167 of FIG. 11, searches the information of the field 169 from ID of the user judged as the target person, and notifies only the information to the intermediation wisher. The information of the table 167 may be constructed by achieving information from a company member information database owned by the company and creating a table in advance. By executing the operation as described above, only the name of the target person is notified to the intermediation wisher, and thus it is actually unnecessary to notify ID of the target person. There is a case where the intermediation wisher can judge the identify of the target person from the name of the target person. When plural target persons are presented from the relevant information sharable/non-sharable information managing server 16, the above information can be used as a material for identifying a person to which the information supply is requested.

### 1-3. Third Operation Pattern

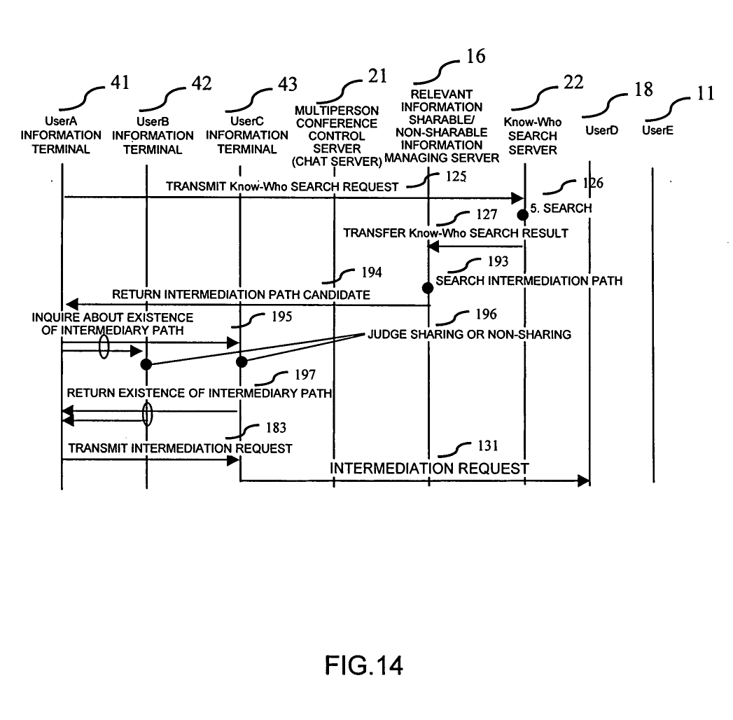

FIG. 14 is a sequence diagram showing a third operation pattern for the potion surrounded by reference numeral 134 of the sequence diagram shown in FIG. 8. As compared with the example of FIG. 8, the operations of the steps 125 to 127 of this sequence are the same as those of FIG. 8. After an intermediation path candidate is searched from the public relevant information in step 193, the search result is returned to UserA in step 194. Refinement of the intermediary from the public relevant information which is carried out in steps 128, 129 of FIG. 8 is carried out by UserA in steps 195, 197. The transmission of the intermediation request of the subsequent step 183 is the same as FIG. 13, and the intermediation request of step 131 is the same as FIG. 8.

As shown in FIG. 14, when UserA directly inquires about the private relevant information to other users, the judgment of “sharable” or “non-sharable” is not carried out on the basis of the database on the relevant information sharable/non-sharable information managing server 16 as shown in the table 141 of FIG. 9, but UserA itself can judge a person with whom UserA shares the relevant information at present. IDs of the intermediary user and the target user are disclosed to UserA, and UserA can select an inquiry destination of the relevant information and select the target person on the basis of UserA's discretion. Accordingly, usability for UserA is enhanced. In this example, a user to which the relevant information is inquired (in this example, UserB, UserC) can judge whether the relevant information between the user concerned and others is disclosed to UserA or not, and thus the relevant information owned by UserB, UserC can be subjected to access control.

In this example, UserA manages which electronic conference room himself/herself stays in at present, and further grasps other members who stay in the same electronic conference room at present. UserA judges sharing partners from these information owned by UserA itself, and as a result inquires to UserB, UserC. Furthermore, UserB, UserC themselves grasp that UserA participates in the same conference room. UserB, UserC judges sharing or non-sharing in response to the inquiry from UserA in step 196. Under the sharable case, it replies in step 196. In this sequence pattern, UserA can select an inquiry destination of private relevant information by itself. For example, each user can select an inquiry destination of a private relevant information on the basis of information which cannot be managed on the database of the relevant information sharable/non-sharable information managing sever 16, such as information of friends, drinking pals, etc. which each user has in his/her mind, information on entrance/exit into/from the electronic conference room of each user, etc., and various information which cannot be represented on the database such as information as to whether each user can actually execute intermediation or has an intermediation capability, etc.

### 1-4. Fourth Operation Pattern

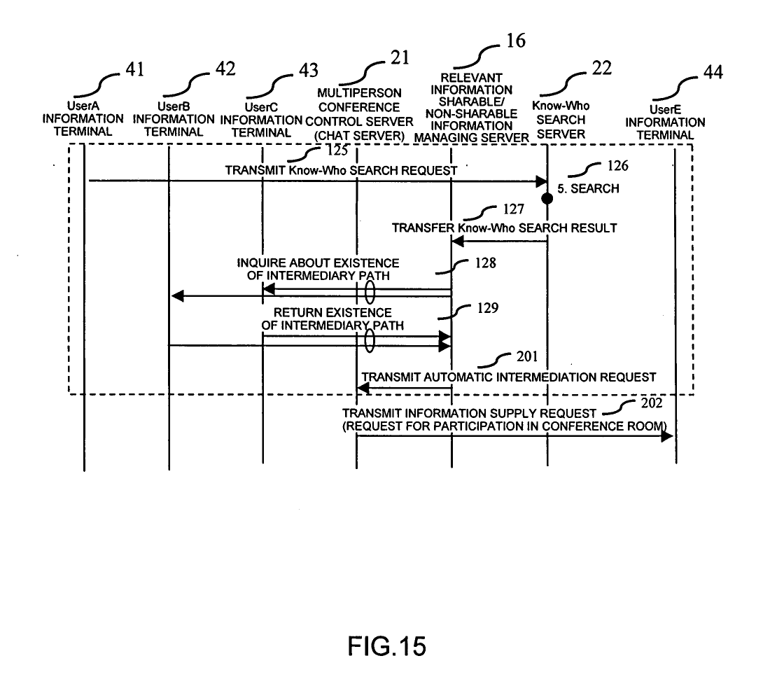

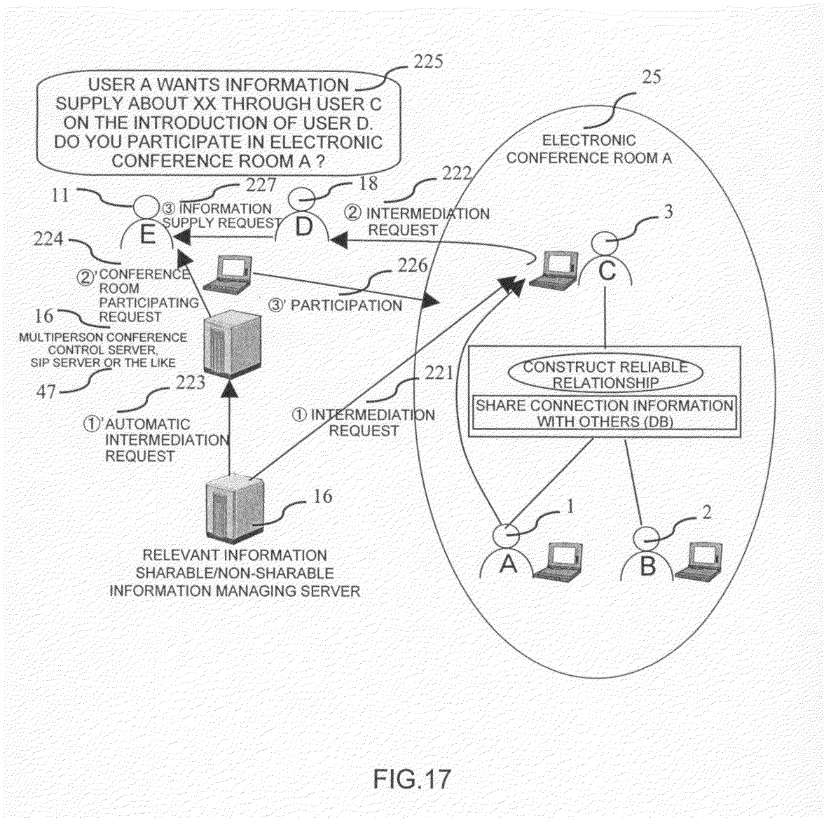

FIG. 15 is a sequence diagram showing a fourth operation pattern for the portion surrounded by reference numeral 134 of the sequence diagram of FIG. 8. As compared with the example of FIG. 8, the operations of the steps 125 to 129 of this sequence are the same as those of FIG. 8. In the sequence of FIG. 8, the intermediation request is transmitted to UserC. In step 201, the intermediation request is transmitted to the multiperson conference control server 21. The multiperson conference control sever 21 transmits a request for participation in a conference to UserE indicated by reference numeral 11 in step 202. By this pattern, UserC as the intermediary can reduce the intermediation load to be actually imposed. Furthermore, the intermediation request work, and the intermediation work are carried out by the server 16 as substitute, and thus the intermediation work can be performed without notifying IDs of other users to the inquiring user and the intermediary. The step 132 of FIG. 8 may be omitted. The difference between this sequence and other sequences will be described with reference to FIG. 17.

FIG. 17 is an intermediation image diagram showing this operation pattern.

The flow of the operations shown in steps 221, 222, 227 of FIG. 17 corresponds to an intermediation implementing method in the sequence other than FIG. 15. In step 221, UserA indicated by reference numeral 1 or the relevant information sharable/non-sharable information managing server 16 transmits an intermediation request to UserC indicated by reference numeral 3. This operation corresponds to the step 130 of FIG. 8 and the step 183 of FIG. 13. On the basis of this intermediation request, UserC transmits an intermediation request to UserD indicated by reference numeral 18 in step 222, and UserD transmits an information supply request to UserE in step 227. These operations correspond to the steps 131, 132 of FIG. 8.

In the sequence shown in FIG. 15, the relevant information sharable/non-sharable information managing server 16 automatically transmits an information request, not to UserC, but to the multiperson conference control server 16 for managing the user's entrance/exit to/from the electronic conference room, or the SIP server 47 for managing the transmission session in step 223 (step 201 of FIG. 15). When receiving the information concerned, these servers transmit to UserE an information supply request and a request for participation in the electronic conference room as indicated in step 224 (step 202 of FIG. 15). Reference numeral 225 represents an example of the content of the participation request. It is described in the content 225 that an information supply wishing user is UserA and the intermediaries are UserC, UserD, and also required information and the request for participating the electronic conference A for information supply are also described in the content 225. UserE indicated by reference numeral 11 receives this message, and participates in the conference room as indicated in step 226 by using the his/her own information terminal 44 to supply information. At this time, the multiperson conference control server 16 and the SIP server 47 controls the communication session by using a control message, and automatically controls the communication so that UserE can participate in the electronic conference room A when UserE allows information supply.

### 2. Second Embodiment

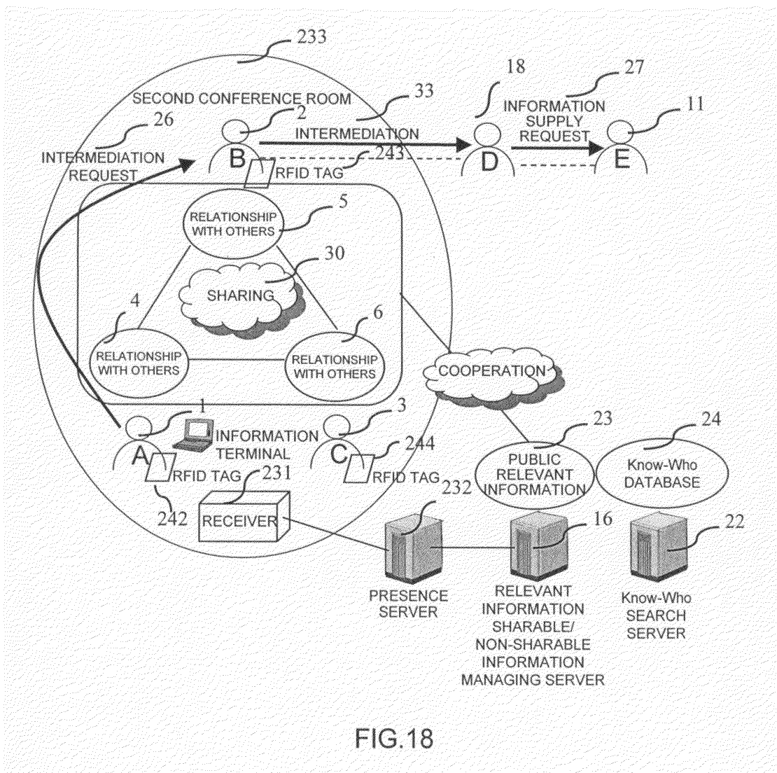

FIG. 18 is a conceptual diagram of the portion surrounded by reference numeral 135 in the sequence diagram of FIG. 8 in the example of FIG. 3 when sharable/non-sharable information is collected by different means.

This system comprises the relevant information sharable/non-sharable information managing server 16, the Know-Who search server 22, a receiver 231, a presence server 232, and RFID (Radio Frequency Identification) tags 242 to 244 owned by each user.

In the example of FIG. 3, the relevant information sharable/non-sharable information managing server 16 judges sharing or non-sharing of private relevant information among users on the basis of the entrance/exit information to an electronic conference room. In this embodiment (the example of FIG. 18), respective users do not argue with one another in an electronic conference room by using a chat, but they gather together in an actual conference room (for example, a second conference room 233) and argue with one another while directly facing one another. Furthermore, a receiver 231 for sensing a wireless signal such as RFID or the like is set up in the conference room in order to grasp how many users stay in the conference room concerned. Information received by this receiver 231 is transmitted to the presence server 232, and treated as presence information of each use. In this example, the location of each user is grasped on the basis of RFID to grasp the entrance/exit of the user concerned. However, other methods may be used. For example, there may be adopted a method in which each user inputs position information from a terminal or the like, and the presence server 232 manages this information.

The “presence information” is information with which “existence” of each user is notified to other uses. Specifically, it is information for indicating the presence position or present state of each user, or various other information for indicating the existence of the user itself. By notifying this “presence” to others on a real-time basis, the present states of the users can be mutually grasped. The concept of “presence” and the communication technique have been developed from IM (Instant Messaging) technique. IM and the concept of “presence” are standardized mainly by the impp (Instant Messaging and Presence Protocol) working group of IETF (Internet Engineering Task Force). The content standardized in the impp working group is described in RFC (Request For Comment) 2778, 2779, for example. The specific presence communication technique is argued and standardized by various working groups of IETF on the basis of the concept defined in impp. In this example, the information achieved by RFID is treated as presence information, and preserved in the presence server 232. The relevant information sharable/non-sharable information managing server 16 judges on the basis of the presence information whether the private relevant information of each user is sharable or non-sharable. The presence information of each user may be achieved by a means other than the electric wave transmission/reception based on RFID and used. Presence information other than the position information, such as a present busyness state, a present state of mind or the like may be used as sharable/non-sharable information.

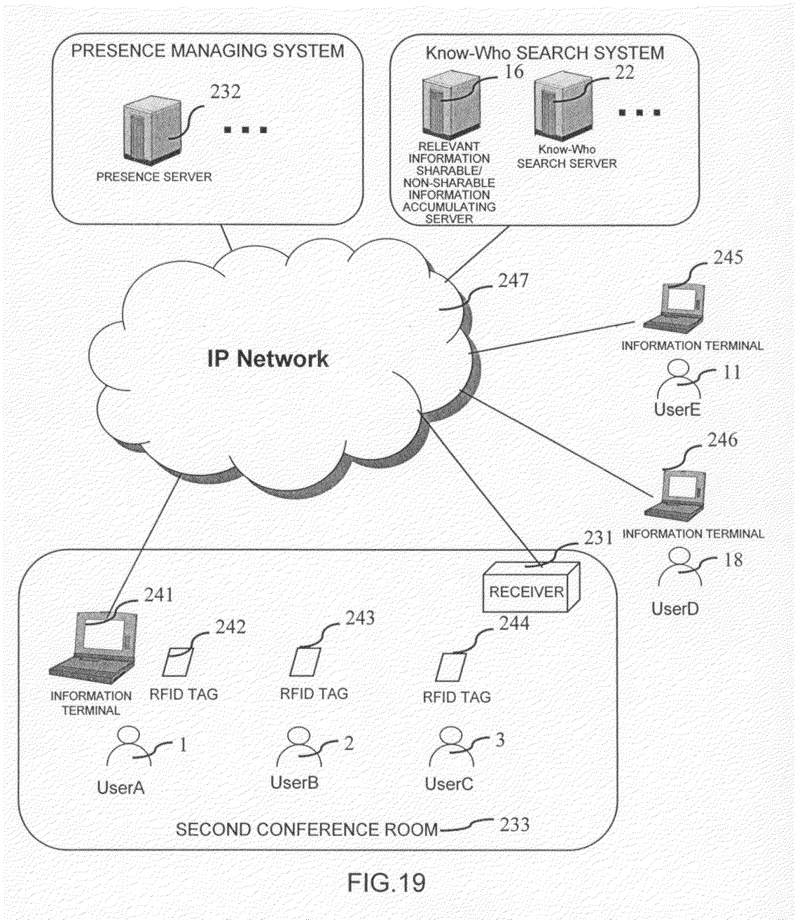

FIG. 19 is a diagram showing the construction of the network of this system. The receiver 231 of RFID set up in the second conference room 233, the presence server 232, the relevant information sharable/non-sharable information managing server 16, the Know-who search server 22 and the information terminals 241, 245, 246 owned by UserA, UserD, UserE respectively are connected to an IP network 247. However, UserD and UserE are not necessarily required to own information terminals, and when they own information terminals, these information terminals are connected to the IP network 247. The terminal 241 may be owned by UserB, C in addition to UserA or may be a terminal placed in the conference room. The relevant information sharable/non-sharable information managing server 16 has public relevant information tables 161, 167 as shown in FIG. 10 as in the case of the first embodiment. Furthermore, each user has private relevant information, and the private relevant information may be stored in the terminal of each user or stored in the relevant information sharable/non-sharable information managing server 16 in advance, for example.

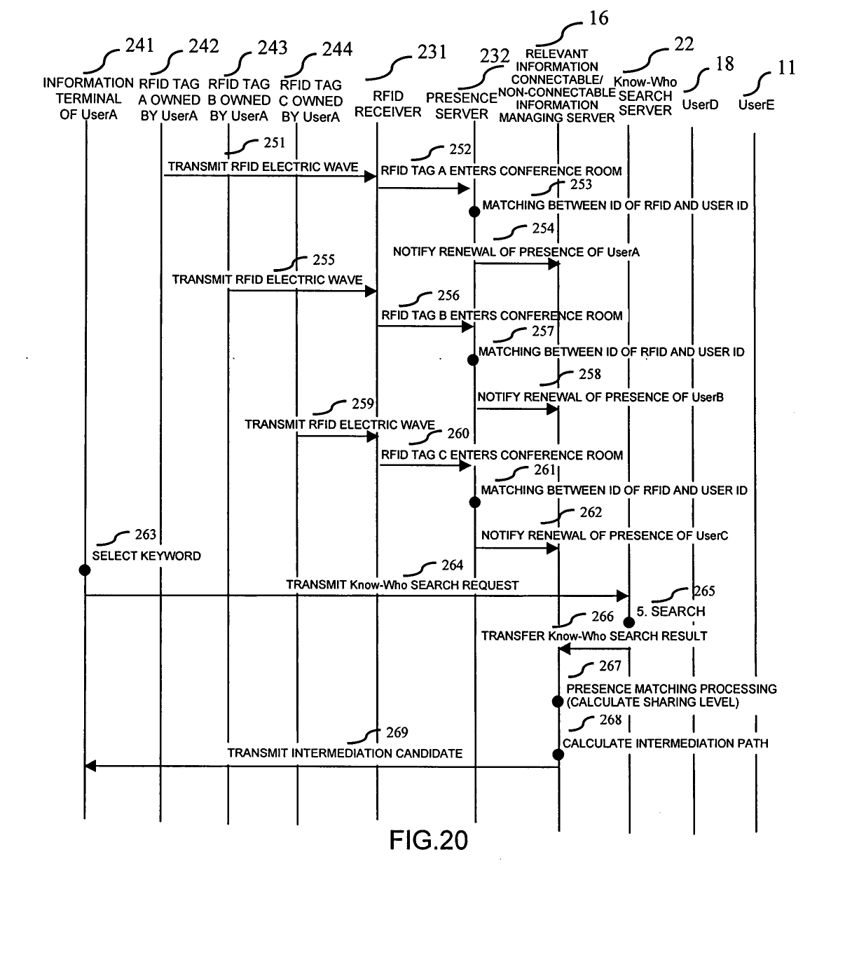

FIG. 20 is a sequence diagram of the portion surrounded by reference numerals 135, 136 of FIG. 8. This sequence is matched with the example of FIG. 18. The sequence subsequent to this portion is set to be identical to the step 183 and subsequent steps of FIG. 13 or the step 195 and subsequent steps of FIG. 14.

In FIG. 20, the RFID tag A242 owned by UserA receives the electric wave emitted from the receiver 231 when the user enters the second conference room 233, and transmits the response to the receiver 231 in step 251. The response contains ID of the RFID tag, for example. The receiver 231 receives the response and transmits the ID of the RFID tag and the identification information thereof to the presence server 232 in step 252.

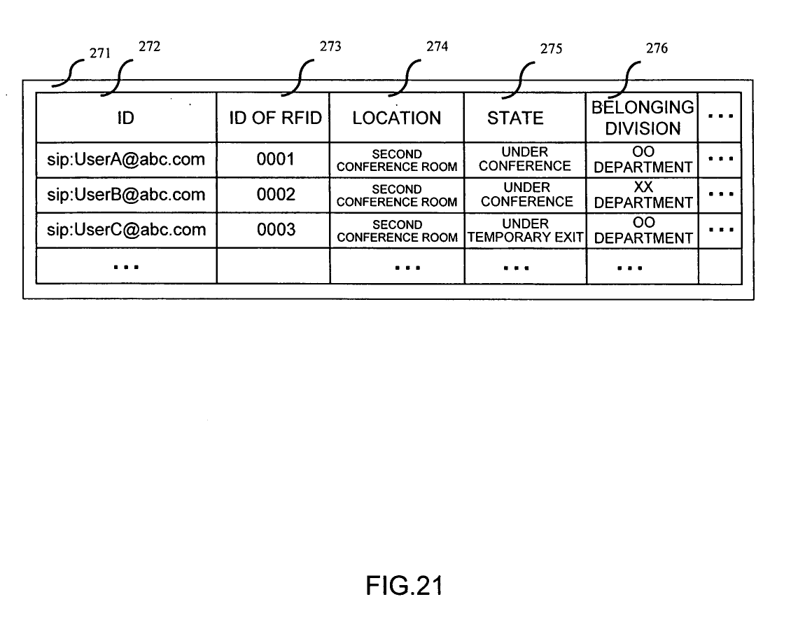

In the presence server 232, the presence information of the user is managed by the table as indicated by reference numeral 271 of FIG. 21. ID of the user and ID of the RFID tag owned by the user are stored in association with each other in the table 271 in advance, for example. In this example, the identifier of the information transmitted from the receiver 231 is 0001 of ID possessed by the RFID tag A. Accordingly, the description of the location field 273 of the first record corresponding to ID “0001” of RFID of the field 273 of the table 271 is renewed to the set-up position of the receiver 232. As a result, the record whose User ID is “sip:UserA@abc.com” is renewed, and the presence information of UserA is renewed. In this example, the presence server 232 manages the association between ID of each RFID and the user ID in the table, and renews the presence of the user while the information received by the signal receiver of RFID is associated with the user ID in step 253. However, the presence server 232 is not necessarily required to have the above function, and this function may be implemented by a physically different sever, or by different software in the physically same server. The presence server 232 further transmits these presence information to the relevant information sharable/non-sharable information managing server 16 in step 254. As a result, the relevant information sharable/non-sharable information managing server 16 preserves the same information as the table 271 in the server. When UserA exists from the second conference room 233, a receiver located at another place carries out the same operation as described above, thereby renewing the presence information. The processing of the steps 255 to 262 of UserB, UserC is the same as the processing of the steps 251 to 254.

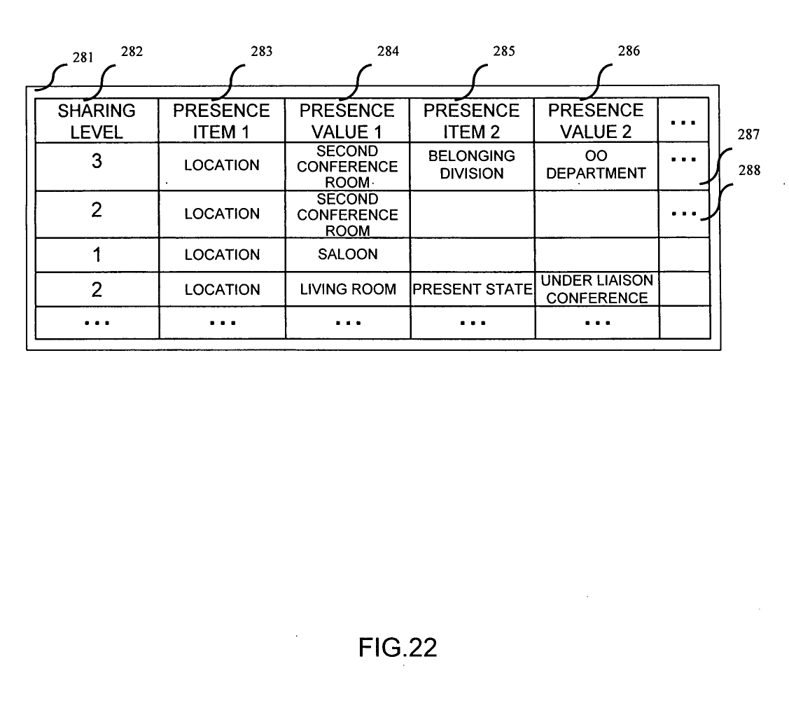

The relevant information sharable/non-sharable information managing server 16 holds information as indicated by a table 281 of FIG. 22 as a template for managing the sharing level. This table 281 has the same role as the table 171 of FIG. 12 in the example of FIG. 3. The standpoint for the table 281 will be described. For example, “location” and “second conference room” are described in a presence item 1 field 283 and in a presence value 1 field 284 respectively as indicated by a record 287, for example. Furthermore, “affiliation” and “OO division” are described in advance in a presence item 2 field 285 and a presence value 2 field 286, respectively. Furthermore, “3” is described in a sharing level field 282. This indicates that the sharing level between users for which the content of the location field 274 of the table 271 of FIG. 21 is matched in “second conference room” and the affiliation field 276 is matched in “OO division” is equal to 3.

In this example, UserA indicated by ID of sip:UserA@abc.com and UserC indicated by sip:UserC@abc.com are matched with this condition, and the sharing level therebetween is equal to 3. When the record 288 of the table 281 is likewise checked, it is found that the sharing level between users which are matched with each other under the condition that “location” is “second conference room” is equal to 2. In this example, the sharing level between UserA and UserB indicated by ID of sip:UserB@abc.com and the sharing level between UserB and UserC are equal to 2. The relationship between the sharing level and the disclosure range of the private relevant information is the same as the first embodiment. For example, in this example, in order to calculate the intermediation path from UserA to the target person E, the private relevant information whose disclosure level is equal to 2 or less is used for UserB, and the private relevant information whose disclosure level is equal to 3 or less is used for UserC.

As described above, by judging the sharing level on the basis of the matching condition of the present information, various matching patterns are generated from plural presence items, and the sharing level can be minutely controlled. In this example, the sharing level judging operation based on the matching processing in the table 281 is carried out in step 267. This operation corresponds to the sharing/non-sharing judgment work by the sharing determining unit 88 of the sharing judging unit 74 of FIG. 6, which is executed before step 128 in the example shown in FIG. 8.

Furthermore, with respect to the operations from the Know-Who search till the intermediation which are indicated by the sequence from steps 263 to 269, there may be adopted any one of many patterns such as a pattern in which the relevant information sharable/non-sharable information managing server 16 executes various operations such as the operation of directly inquiring to each user about the existence of an intermediary path and calculating an intermediation path, the operation of making an intermediation request, etc. by duty as shown in FIG. 8, a pattern in which the server executes the operation from the inquiry to each user about the existence of the intermediation path till the calculation of the intermediation path, and returns the result to the inquiring user, and then each user executes the intermediation request work as shown in FIG. 13, a pattern in which the server calculates only the candidate of the target person and the intermediation path candidate and returns the result to the inquiring user, and then the inquiring user inquires to other users about the existence of the intermediation path and executes the intermediation work as shown in FIG. 14, and a pattern in which the intermediation work is automatically executed without requesting to each user.

However, in the case of the example of FIG. 18, it may be impossible to use the sequence pattern in which the relevant information sharable/non-sharable information managing server 16 transmits the intermediation request to UserC as shown in FIG. 8 or the like. This is because UserC may possess no terminal at hand under the conference in the second conference room 233. In this case, UserA directly requests intermediation to UserC as indicated in step 183 in the pattern of FIG. 13. In this case, the intermediation request is not output by transmission/reception of an electronic message, but the intermediation request is directly output orally. Furthermore, the private relevant information is stored in advance in the server as shown in FIG. 16. When the intermediation request is orally output as described above, it is impossible to carry out the intermediation unless the target person is disclosed to UserA by using the intermediation ID as shown in FIG. 25. For the same reason as described above, if UserC does not possess any information terminal at hand, it would be impossible to inquiry to the relevant information sharable/non-sharable information managing server 16 through the IP network about a user to be next relayed even when the intermediation ID is notified.

Furthermore, as indicated by reference numerals 217, 218 and 219 of FIG. 16, there may be a case where each user cannot hold the private relevant information in its own terminal and thus UserA cannot directly inquire to each user about the private relevant information as indicated by the step 195 of FIG. 14. The reason for this is the same as described above, that is, there may be a case where UserB, UserC possesses no information terminal, an information terminal of UserB, UserC is not connected to the IP network 246 even when UserB, UserC posses the information terminal or the information terminal concerned is not powered on. In such a case, the private relevant information is managed at the server side as indicated by reference numerals 212, 213 and 214 of FIG. 16 to be subjected to access control, whereby an inquiry about private relevant information is implemented.

Furthermore, as shown in FIG. 15, for example the relevant information sharable/non-sharable information managing server 16 can transmit the intermediation request to UserE in the pattern in which intermediation is automatically carried out.

In the first and second embodiments described above, the intermediation request and the information supply request may be directly communicated among users in place of the communication among users. In this case, the terminal displays the searched and received intermediation path on the display portion thereof, and the user intermediates according to the display of the display portion. Furthermore, in the first embodiment, the respective operation patterns may be suitably combined.

The present invention is applicable to the Know-Who system. Furthermore, the present invention is applicable to a system for controlling information disclosure.

What is claimed is:

1. An information sharing control system comprising:
plural terminals for holding private relevant information containing identification information of other terminals or users, the private relevant information being created on the basis of transmitted/received e-mails or non-disclosed information or non-disclosed medium; and
a first server for receiving a request for participation in an application or a group from each of the terminals and storing attribute information for associating the identification information of the terminal with the identification information of the application or the group,
wherein
respective terminals belonging to the same application or group temporarily share the private relevant information thereof on the basis of the attribute information.

2. The information sharing control system according to claim 1, further comprising:
a second sever that has a database for storing identification information of users and information known by the users in association with each other, receives an information search request from a first terminal of the plural terminals, achieves the identification information of an information supply user knowing requested information by referring to the database, and transmits the identification information of the information supply user and the identification information of the first terminal; and
a third server for holding public relevant information in which identification information of mutually relevant terminals or users are associated with one another, the public relevant information being created on the basis of disclosed or disclosure-scheduled information or medium, receiving the identification information of the first terminal and the identification information of the information supply user from the second server, and referring to any one or plural of the private relevant information shared by respective terminals of an application or a group to which the first terminal belongs to, the public relevant information and the identification information of respective terminals of the application or the group to which the first terminal belongs to, thereby determining identification information of one or plural intermediation terminals or users which carry out the intermediation from the first terminal to the information supply user.

3. The information sharing control system according to claim 2, wherein
the third server, according to the identification information of determined intermediation terminals, transmits an intermediation request to one of the intermediation terminals, and
the intermediation terminal, in response to the received intermediation request, transmits an intermediation request to another intermediation terminal, or transmits to the terminal of the information supply user an information supply request indicating that there is an information supply request from the first terminal, or displays it on a display portion of the terminal itself that there is an intermediation request to the information supply user.

4. The information sharing control system according to claim 2, wherein
the third server sets an intermediation identifier, stores the set intermediation identifier in connection with the identification information of the first terminal, the identification information of the determined intermediation terminal and the identification information of the information supply user, and transmits intermediation candidate information containing the intermediation identifier and the identification information of the intermediation terminal to the first terminal;
the first terminal transmits the intermediation request containing the intermediation identifier to the intermediation terminal according to the intermediation candidate information;
the intermediation terminal transmits the intermediation identifier contained in the received intermediation request to the third server to inquiry about an intermediation destination;
the second server reads out the identification information of the information supply user corresponding to the intermediation identifier or identification information of another intermediation terminal for further intermediating in response to the inquiry, and transmits the identification information to the intermediation terminal; and
the intermediation terminal transmits the information supply request to the terminal of the user concerned on the basis of the received identification information of the information supply user, or transmits the intermediation request on the basis of the received identification information of the other intermediation terminal.

5. The information sharing control system according to claim 1, wherein
the first server is a server for managing entrance/exit into/from an electronic conference room, and
the attribute information is information of entrance/exist into/from the electronic conference room.

6. The information sharing control system according to claim 1, wherein
the private relevant information is held in each of the terminals, and each of the terminals and the third server communicate with each other or the terminals communicated with one another, thereby searching an intermediation terminal to the information supply user.

7. The information sharing control system according to claim 1, wherein
each terminal registers the private relevant information into the second server, and
the third server carries out access control on the registered private relevant information on the basis of the attribute information.

8. The information sharing control system according to claim 1, wherein
the terminal identifies a terminal belonging to the same application or group by referring to the attribute information stored in the first server or referring to the attribute information which is received from the first server and stored in advance.

9. The information sharing control system according to claim 1, wherein
the third server identifies a terminal belonging to the same application or group by referring to the attribute information stored in the first server or referring to the attribute information which is received from the first server and stored in advance.

10. The information sharing control system according to claim 1, wherein
a sharing level is defined every application or group,
a disclosure level for the private relevant information is defined for every identification information of another terminal or user, and
a sharing range of the private relevant information is limited in accordance with the sharing level and the disclosure level.

11. The information sharing control system according to claim 1, wherein
the third server sets a common symbol in connection with an intermediation path containing an intermediation terminal and an information supply user, distributes the common symbol to the first terminal, the terminal of the information supply user and/or the intermediation terminal, and returns disclosure-allowed information through each path corresponding to the common symbol in response to an inquiry containing the common symbol, thereby controlling information disclosure of each terminal.

12. The information sharing control system according to claim 11, wherein
the disclosure-allowed information is the name of each user or disclosed user's identification information.

13. The information sharing control system according to claim 2, wherein
the third server transmits the identification information of plural determined intermediation terminals to the first terminal, and
the first terminal selects one of the identification information of the plural intermediation terminals and transmits an intermediation request to the intermediation terminal concerned.

14. The information sharing control system according to claim 2, wherein
the third server automatically selects one of the identification information of determined plural intermediation terminals and transmits an intermediation request to the intermediation terminal.

15. The information sharing control system according to claim 2, wherein
the third server transmits an intermediation request to the first server, and
the first server transmits to the terminal of the information supply user the information supply request containing the identification information of the intermediation terminal and the identification information of the first terminal, or the request for participation in the application or the group to which the first terminal belongs.

16. An information sharing control system comprising:
plural terminals for holding private relevant information containing identification information of other terminals or users, the private relevant information being created on the basis of transmitted/received e-mails or non-disclosed information or non-disclosed medium;
a first server for receiving a request for participation in an application or a group from each of the terminals and storing attribute information for associating the identification information of the terminal with the identification information of the application or the group;
a second sever that has a database for storing identification information of users and information known by the users in association with each other, receives an information search request from a first terminal of the plural terminals, achieves the identification information of an information supply user knowing requested information by referring to the database, and transmits the identification information of the information supply user and the identification information of the first terminal; and
a third server for holding public relevant information in which identification information of mutually relevant terminals or users are associated with one another, the public relevant information being created on the basis of disclosed or disclosure-scheduled information or medium,
wherein the third server
receives the identification of the information supply user and the identification information of the first terminal from the second server,
determines identification information of each terminal belonging to the application or the group corresponding to the received identification information of the first terminal,
determines the identification information of the second intermediation terminal corresponding to the identification information of the first intermediation terminal corresponding to the received identification information of the information supply user or the identification information of the information supply user which is determined on the basis of the public relevant information, on the basis of the private relevant information of the terminal concerned, and
transmits an intermediation request to a second terminal according to the identification information of the determined second intermediation terminal;
the second intermediation terminal transmits an information supply request containing the identification information of the first terminal to the terminal of the information supply user directly or through the first intermediation terminal; and
the terminal of the information supply user displays the identification information of the first terminal on a display portion thereof and
according to the displayed identification information of the first terminal, the information supply user supplies the requested information to the user of the first terminal, whereby the requested information is supplied to the first terminal without disclosing the identification information of the intermediation terminal and the information supply user to the first terminal.

17. An information sharing control system comprising:
a fourth server for storing dynamically varying attribute information containing the position information and/or present state of each user for each identification information of the users;
a registering unit for registering the attribute information of each user into the fourth server; and
a terminal of each user or a third server for holding private relevant information containing identification information of other users, the private relevant information being created on the basis of transmitted/received e-mails or non-disclosed information or medium,
wherein
with respect to users having the same position information or predetermined presence information on the basis of the attribute information, the terminals of the users or the third server temporarily shares the private relevant information of the users respectively.

18. The information sharing control system according to claim 17, wherein
the registering unit has
plural wireless tags, and
a receiver for receiving wireless tag identification information from the wireless tag when a user having the wireless tag approaches to the receiver, and transmitting the identification information of the receiver and the received identification information of the wireless tag to the fourth server,
wherein
the fourth server specifies position information about the set-up position of the receiver on the basis of the identification information of the receiver which is received from the receiver, specifies the identification information of the user on the basis of the identification information of the wireless tag, and stores the identification information of the user and the position information in association with each other.

19. The information sharing control system according to claim 17, further comprising
a second server that has a database in which identification information of users and information known by the users are stored in association with each other, receives an information search request from the first terminal, achieves the identification information of an information supply user knowing requested information by referring to the database, and transmits the identification information of the information supply user and the identification information of the first terminal,
wherein the third server
holds public relevant information which is created on the basis of disclosed or disclosure-scheduled information or medium and in which identification information of mutually-relevant terminals or users are stored in association with one another,
receives the identification information of the information supply user and the identification information of the first terminal from the second server, and
determines identification information of one or plural intermediation terminals or users who carry out intermediation from the first terminal to the information supply user by referring to any one or a plurality of the private relevant information shared by respective users who have the same position information or presence information as the first terminal, the public relevant information and the identification information of the respective users who have the same position information or presence information as the first terminal.

20. The information sharing control system according to claim 17, wherein
a sharing level is defined in connection with each information contained in attribute information,
a disclosure level is defined with respect to private relevant information between users for every user's identification information,
the sharing level is determined on the basis of the attribute information, and a sharing range of the private relevant information is limited in accordance with the sharing level and the disclosure level.

21. The information sharing control system according to claim 17, wherein
the attribute information further contains static information representing a feature of each user containing any one or a plurality of an affiliated department, age and sexuality of each user.
